(19) United States
(12) Patent Application Publication
(10) Pub. No.: US 2009/0233048 A1
(43) Pub. Date: Sep. 17, 2009

(54) Anti-glare material and optical layered product

(76) Inventors: Chikara Murata, Shizuoka-shi (JP); Kazuya Ooishi, Shizuoka-shi (JP); Masaomi Kuwabara, Shizuoka-shi (JP); Hideki Moriuchi, Shizuoka-shi (JP)

Correspondence Address: JORDAN AND HAMBURG LLP, 122 EAST 42ND STREET, SUITE 4000, NEW YORK, NY, 10168, US

(21) Appl. No.: 12/313,111

(22) Filed: Nov. 17, 2008

(30) Foreign Application Priority Data
Nov. 19, 2007 (JP) 2007-299882
Sep. 27, 2008 (JP) 2008-249341

(51) Int. Cl. B32B 3/00; B32B 5/16; B05D 5/06

(52) U.S. Cl. 428/143; 428/141; 428/329; 427/162

(57) ABSTRACT

An anti-glare material comprises irregularity shape formed over at least one side. The side comprising the irregularity shape has slope angles satisfying the distribution conditions according to the formulae (1) and (2):

A≦0.2 (1) and

0.8≦B≦2.5 (2)
wherein
A: proportion of slope angles at or greater than 1.6° in relation to the total, B: (proportion of slope angles at or greater than 0.4° and smaller than 1.6° in relation to the total)/(proportion of slope angles less than 0.4° in relation to the total).

### TECHNICAL FIELD

The present invention (1) relates to anti-glare materials to be provided on display surfaces of liquid crystal displays (LCDs), plasma displays (PDPs) and the like and, in particular, to anti-glare materials, in which high contrast and anti-scintillation are required, to be suitably used for large sized high-resolution liquid crystal television sets 30 inches or more in size, for example. The present invention (2) relates to optical layered products to be provided on display surfaces of LCDs, PDPs and the like and, in particular, to optical layered products for improving visibility of screens.

### BACKGROUND OF THE INVENTION

Recently, displays such as LCDs and PDPs have been improved so that they can be produced and sold in various sizes for a number of applications ranging from cell phones to large-size television sets.

Such displays may have impaired visibility due to glare into the display surfaces of room lightings such as fluorescent lights, sunlight incident through windows and shadows of an operator. As such, in order to improve visibility, the display surfaces are provided with functional films on the outermost surface, such as anti-glare films having microirregularity structure, which are capable of diffusing surface-reflected lights, suppressing specular reflections of external lighting and preventing glare of outside environments (having anti-glare properties) (conventional AG).

These functional films are generally produced and sold as products comprising a translucent substrate such as polyethylene terephthalate (hereinafter referred to as “PET”) or triacetyl cellulose (hereinafter referred to “TAC”) on which a single anti-glare layer having microirregularity structure is provided or as products comprising a light diffusion layer on which a low-refractive index layer is layered. Development is also in progress for optical films providing desired functions through combinations of layer configurations.

Recently, along with increases in size, high resolution and enhanced contrast of displays, however, there is now a need for further enhancement of performance required for such functional films.

When an anti-glare film is used for the outermost surface of the display, the light diffusion effect of the anti-glare film for introducing anti-glare properties acts adversely to render images in black whiter and decrease contrast. These problems were especially prominent in a bright room such as living room. An anti-glare film is therefore needed which can attain a high contrast even at the sacrifice to some degree of anti-glare properties by the light diffusion effect (high-contrast AG).

In order to attain high contrast, a method has also been adopted in which the top layer of an anti-glare film is provided with one low-reflection layer or multiple alternate high- and low-refractive index layers (AG with low-reflection layer).

On the other hand, when an anti-glare film is used on the outermost surface, a problem arises in which scintillation (portions with varied brightness) appears on the surface supposedly attributable to microirregularity structure, decreasing visibility. Such scintillation is likely to occur in association with high resolution in association with an increase in number of pixels for a display and with improvement in display techniques such as pixel division schemes. Anti-glare films having anti-scintillation effects are therefore desired (high resolution AG).

In order to attain anti-scintillation effects, development is in progress for a method as in Patent Reference 1, in which mean spacing of profile irregularities (Sm), centerline average surface roughness (Ra) and ten-point average surface roughness (Rz) of the surface of functional films are specifically defined and for a method for regulating background reflection of external lighting into a screen, scintillation phenomenon and white blurring as in Patent References 2 and 3, in which ranges of surface haze and internal haze are closely defined. As such, in designing light diffusion sheets to be used for high resolution LCDs, internal diffusion properties for providing anti-scintillation effects and surface diffusion properties for providing prevention effect of white blurring are controlled.

Patent Reference 1: Japanese Unexamined Patent Publication No. 2002-196117

Patent Reference 2: Japanese Unexamined Patent Publication No. 1999-305010

Patent Reference 3: Japanese Unexamined Patent Publication No. 2002-267818

### DISCLOSURE OF THE INVENTION

### Problems to be Solved by the Invention

The inventions described in these patent references are subject to a tradeoff relationship in which one function selected from anti-glare, contrast enhancing and anti-scintillation functions can be satisfied only at the sacrifice of the others. These problems were likely to occur in large-size screens rather than small-size screens and, in particular, glare of external lighting were difficult to solve. Thus, these functions were not satisfied with a simple configuration comprising a translucent substrate on which a single anti-glare layer is layered. As such, as a method for providing these functions simultaneously, development is in progress with respect to the surface topography or the like of membranes and films to be layered in a multi-layer manner. Such multi-layering however requires a process for coating a translucent substrate with multiple layers, incurring more costs. Also, it is difficult to adjust the balance among the layers provided by the multi-layering, only allowing in fact to implement some functions selected from the anti-glare, contrast enhancing and anti-scintillation functions according to an intended use.

Therefore, the present invention (1) has an object to provide anti-glare materials applicable to high resolution LCDs, which have anti-glare, contrast enhancing and anti-scintillation functions in a balanced manner.

Conventionally, silica has been a typical translucent filler. As requirements for picture quality of displays (contrast, anti-glaring, scintillation) become stringent, however, organic fillers in which refractive indices, particle sizes and like can easily be engineered are gaining popularity. Such translucent organic fillers (translucent organic compound particles) are generally soft in comparison with inorganic fillers such as silica and, therefore, have such problems that surface portions formed in a convex manner by filler (with resin being raised in such a manner as to cover filler) can selectively be scraped to sustain scratches and produce differences in contrast from peripheral portions. As such, the present invention (2) has an object of providing optical layered products having high scratch resistance, while also satisfying requirements for contrast enhancement, anti-glaring and scintillation, with the use of organic fillers.

### Means for Solving Problems

As a result of keen studying, the present inventor has found that, through forming microirregularity shape over the surface of anti-glare materials and also optimizing the distribution of slope angles of the microirregularity shape, a range exists within which all the anti-glare, contrast enhancing and anti-scintillation functions, which have been subject to a tradeoff relationship, are optimized, to successfully accomplish the present invention.

The present invention (1) is an anti-glare material comprising irregularity shape formed over at least one side, wherein the side comprising the irregularity shape has slope angles satisfying the distribution conditions according to the formulae (1) and (2):

A≦0.2 (1) and

0.8≦B≦2.5 (2)

wherein

A: proportion of slope angles at or greater than 1.6° in relation to the total, B: (proportion of slope angles at or greater than 0.4° and smaller than 1.6° in relation to the total)/(proportion of slope angles less than 0.4° in relation to the total).

It is also preferred that the anti-glare material comprises a translucent substrate on which a resin layer is layered and it is preferred that the resin layer includes translucent resin fine particles and comprises the irregularity shape formed over the surface opposite to the surface on which the translucent substrate is layered.

It is preferred that the irregularity shape have a mean spacing of profile irregularities (Sm) of 50 to 250 μm and it is preferred that the anti-glare material has an internal haze of 5 to 40.

Further, it is preferred that a low-reflection layer is layered on the resin layer.

The present invention (2-1) is an optical layered product comprising at least an optically functional layer provided directly or via another layer on one or both sides of a translucent substrate, wherein the optically functional layer contains:

a translucent resin as a matrix;

a translucent organic filler dispersed through the translucent resin; and

metal oxide fine particles having a particle size of 1 to 100 nm, incorporated at a mix proportion of 0.1 to 10% by weight, the metal oxide fine particles being unevenly distributed toward the surface of the translucent organic filler.

The present invention (2-1-2) is an optical layered product comprising at least an optically functional layer provided directly or via another layer on one or both sides of a translucent substrate, wherein the optically functional layer is a layer formed by applying a coating material made by mixing at least an energy-curable resin composition, a translucent organic filler and a metal oxide sol to one or both sides of a translucent substrate directly or via another layer; and then applying an energy to cure the energy-curable resin composition.

The present invention (2-1-3) is an optical layered product comprising at least an optically functional layer provided directly or via another layer on one or both sides of a translucent substrate, wherein the optically functional layer contains:

a translucent resin as a matrix;

a translucent organic filler dispersed through the translucent resin; and

metal oxide fine particles having a particle size of 1 to 100 nm, the metal oxide fine particles being sprinkled over the entire surface of the translucent organic filler.

The present invention (2-2) is the optical layered product according to the invention (2-1) wherein the metal oxide fine particles are alumina fine particles.

The present invention (2-3) is a process for producing an optical layered product, comprising the steps of

applying a coating material made by mixing at least an energy-curable resin composition, a translucent organic filler and a metal oxide sol to one or both sides of a translucent substrate directly or via another layer; and

after the step of applying, applying an energy to cure the energy-curable resin composition to form an optically functional layer.

The present invention (2-4) is the process for producing the optical layered product according to the invention (2-3) wherein the metal oxide sol is alumina sol.

Some of the terms used in the specification and claims will now be defined. The term “over the surface of the translucent organic filler” refers to not only the case where the metal oxide fine particles are attached on the surface of the translucent organic filler but also the case where the metal oxide fine particles are not attached on the surface of the translucent organic filler but are located toward the surface of the translucent organic filler (within 10% of the diameter from the surface). An “energy” refers to energy ray (electron ray or ultraviolet ray, for example) or heat. The term “applying a coating material” is a concept encompassing coating, spraying, immersion or the like.

### Effect of the Invention

The anti-glare material according to the present invention (1) possesses such functions as anti-glaring, contrast enhancement and anti-scintillation in a balanced manner and is capable of providing highly visible, quality displays when used for display surfaces. Also, a reduction of the number of coating processes can simultaneously enable a cost reduction.

According to the present invention (2-1), since the surface of the translucent organic filler is protected by the metal oxide fine particles to render the filler rigid and tough, such an effect is obtained that scratching due to deformation of the filler can be prevented and scratch resistance can be increased. Also, since the metal oxide fine particles are unevenly distributed toward the surface of the translucent organic filler to increase adhesion between the translucent organic filler and the translucent resin, such an effect is obtained that the scratch resistance can further be increased. Further, since the metal fine particles are small in size to minimize optical influences, such an effect is obtained that problems such as increased haze, decreased transmission and decreased contrast are less likely to be caused.

According to the present invention (2-2), in addition to the effects described above, scratch resistance and surface hardness will greatly increase.

According to the present inventions (2-3) and (2-4), with the use of a metal oxide sol as a source of metal oxide fine particles, compatibility with a resin will increase to make it more easily coatable. Also, the metal oxide fine particles are less likely to agglomerate, enabling to afford optical functions uniformly.

### DETAILED DESCRIPTION OF THE PREFERRED EMBODIMENTS

### Present Invention (1)

The anti-glare material according to the preferred embodiment basically comprises irregularity shape formed on at least one side of an anti-glare material in such a manner that predetermined slope angles are distributed. The irregularity shape may be formed on one side of the anti-glare material or on the both sides of the anti-glare material.

Anti-glare materials in the present invention are not particularly limited, examples of which may include translucent substrates alone, translucent substrates on which resin layers are layered and resin layers alone. A resin layer alone may be obtained by forming a resin layer on a substrate such as a translucent substrate and then peeling off the resin layer.

When a resin layer is layered on a translucent substrate, a translucent substrate having predetermined irregularity shape over one side may be layered with a resin layer on the other side, or a translucent substrate having predetermined irregularity shape may be layered with a resin layer on that side having the predetermined irregularity shape. Alternatively, a resin layer may be layered on a translucent substrate before forming predetermined irregularity shape over the resin layer. Furthermore, a resin layer containing translucent fine particles may be layered on a translucent substrate.

Also, incorporating translucent fine particles in a resin layer can form desired irregularity shape over a side of the resin layer.

The anti-glare material according to the present invention may have other layers in addition to the translucent substrate and the resin layer. Examples of such other layers may include a polarizing substrate, a low-reflection layer and another function-imparting layer, such as an antistatic layer, a near infrared ray (NIR) absorption layer, a neon shielding layer, an electromagnetic wave shielding layer or a hard coat layer. For example, such a layer may be located on one side of the translucent substrate, on the both sides of the translucent substrate, between the translucent substrate and the resin layer, or on a resin layer layered on the translucent substrate.

The anti-glare material according to the preferred embodiment will specifically be described below.

<Translucent Substrate>

The translucent substrates for composing the present invention are not particularly limited as long as they are translucent. Glasses such as quartz glass and soda is glass may be used. However, various resin films of PET, TAC, polyethylene naphthalate (PEN), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymers (COC), norbornene-containing resins, polyether sulfone, cellophane, aromatic polyamides and the like may preferably be used. For use in PDPs and LCDs, films of PET and TAC are more preferred.

The transparency of such translucent substrates is preferably as high as possible. The total transmittance (JIS K7105) of the substrates is preferably 80% or higher and more preferably 90% or higher. The thickness of the translucent substrates is preferably smaller in view of weight saving. In consideration of productivity and ease of handling, however, substrates having a thickness in the range of 1 to 700 μm and preferably in the range of 25 to 250 μm are preferably used.

Also, the adherence between the translucent substrate and the resin layer and other layers can be enhanced by subjecting the translucent substrate to surface treatment such as alkali treatment, corona treatment, plasma treatment, sputtering and saponification and/or surfacetreatment such as coating of surfactants, silane coupling agents or the like or Si vapor deposition.

<Resin Layer>

Next, the resin layer according to the preferred embodiment will be described in detail. Materials for composing the resin layers according to the preferred embodiment are not particularly limited. However, radiation-curable resin compositions are preferably used. A radiation curable resin composition refers to a resin composition curable by radiations such as heat and ultraviolet rays and can reduce installation costs and improve productivity. Examples of radiation-curable resin compositions include monomers, oligomers and prepolymers having radically polymerizable functional groups such as acryloyl, methacryloyl, acryloyloxy and methacryloyloxy groups or cationically polymerizable functional groups such as epoxy, vinyl ether and oxetane groups. Such monomers, oligomers and prepolymers can be used alone or in combination as appropriate. Examples of monomers may include methyl acrylate, methyl methacrylate, methoxy polyethylene methacrylate, cyclohexyl methacrylate, phenoxyethyl methacrylate, ethylene glycol dimethacrylate, dipentaerythritol hexaacrylate, trimethylolpropane trimethacrylate and pentaerythritol triacrylate. Examples of oligomers and prepolymers may include acrylate compounds such as polyester acrylates, polyurethane acrylates, multifunctional urethane acrylates, epoxy acrylates, polyether acrylates, alkyd acrylates, melamine acrylates and silicone acrylates, unsaturated polyesters, epoxy-based compounds such as tetramethylene glycol diglycidyl ether, propylene glycol diglycidyl ether, neopentyl glycol diglycidyl ether, bisphenol-A diglycidyl ether and various cycloaliphatic epoxies as well as oxetane compounds such as 3-ethyl-3-hydroxymethyl oxetane, 1,4-bis-{[(3-ethyl-3-oxetanyl)methoxy]methyl}benzene and di[1-ethyl-(3-oxetanyl)]methyl ether. Such oligomers and prepolymers can be used alone or in combination.

The radiation-curable resin compositions can be cured as such by irradiation with electron rays. When they are cured by irradiation with ultraviolet rays, however, addition of photopolymerization initiators will be needed. Radiations to be used may be ultraviolet rays, visible lights, infrared rays or electron rays. Also, these radiations may be polarized or non-polarized. Examples of photopolymerization initiators include radical polymerization initiators, such as acetophenones, benzophenones, thioxanthones, benzoin and benzoin methyl ether as well as cationic polymerization initiators, such as aromatic diazonium salts, aromatic sulfonium salts, aromatic iodonium salts and metallocene compounds. Such photopolymerization initiators can be used alone or in combination as appropriate.

According to the preferred embodiment, polymeric resins may be added to the radiation-curable resin compositions to such an extent that the polymerization curing may not be prevented. Such polymeric resins are thermoplastic resins soluble in organic solvents to be used for coating materials for resin layers to be subsequently referred to, specific examples of which may include acrylic resins, alkyd resins and polyester resins. Such resins preferably contain acidic functional groups such as carboxyl, phosphoric and sulfonic groups.

Also, additives such as leveling agents, viscous agents and antistatic agents may be contained in the radiation-curable resin compositions. The leveling agents work to equalize the surface tension of coatings to repair any defects before formation of coatings. Substances lower in both boundary tension and surface tension than the radiation-curable resin compositions described above are used as leveling agents. The viscous agents work to impart thixotropy to the radiation-curable resin compositions described above and are effective in formation of microirregularity shape over the surface of resin layers due to the prevention of translucent resin fine particles, pigments and the like from precipitation to be subsequently referred to.

The resin layer according to the prevent invention is preferably composed of a cured product of a radiation-curable resin composition which may contain macromolecular resins and additives as necessary. A process for forming a radiation-curable resin layer comprises applying a coating material comprising a radiation-curable resin composition and an organic solvent on a translucent substrate and volatilizing the organic solvent, before irradiating with a radiation (electron ray or ultraviolet ray, for example) to effect curing. Organic solvents to be used here must be selected among those preferable for dissolving the radiation-curable resin composition. Specifically, solvents selected from alcohols, esters, ketones, ethers and aromatic hydrocarbons may be used alone or in combination, in consideration of coatabilities such as wettability toward translucent substrates, viscosity and drying rate.

The thickness of the resin layer is preferably in the range of 1.0 to 12.0 μm, more preferably in the range of 2.0 to 11.0 μm and even more preferably in the range of 3.0 to 10.0 μm. When the resin layer is smaller than 1.0 μm in thickness, insufficient curing may occur due to oxygen inhibition during ultraviolet ray curing to deteriorate abrasion resistance of the resin layer and, when the resin layer is larger than 12.0 μm in thickness, curing shrinkage of the resin layer may cause curls, microcracks, a decrease in adhesion in relation to the translucent substrate or a decrease in translucency. It may also cause a cost increase due to an increase in coating material needed in association with an increase in film thickness.

<Translucent Fine Particles>

Microirregularity shape can be formed on the surface of the resin layer by incorporating translucent fine particles in the resin layer. When translucent fine particles are incorporated in the resin layer, a radiation-curable resin composition is preferably used as the resin layer. By using such a radiation-curable resin composition, a difference in refractive index from the translucent fine particles may easily be reduced to 0.2 or less, so that a suitable total transmittance may be maintained.

As translucent resin fine particles, organic translucent resin fine particles composed of acrylic resins, polystyrene resins, styrene-acrylic copolymers, polyethylene resins, epoxy resins, silicone resins, polyvinylidene fluoride, polyethylene fluoride resins and the like may be used. The refractive index of the translucent resin fine particles is preferably from 1.40 to 1.75. When the refractive index is smaller than 1.40 or larger than 1.75, a difference in refractive index from the translucent substrate or the resin matrix (the total solid content of the resin layer minus the translucent fine particles) will be too great, lowering the total transmittance.

The average particle size of the translucent resin fine particles is preferably in the range of 0.3 to 10 μm and more preferably in the range of 1 to 5 μm. Particle sizes smaller than 0.3 μm are not preferred, because anti-glare properties will deteriorate, while particle sizes larger than 10 μm are not preferred either, because scintillation will occur and the degree of surface irregularity shape will be so great that the surface may turn whitish. Also, the proportions of the translucent resin fine particles to be contained in the resin described above are not particularly limited. It is, however, preferred that the proportions are from 1 to 20 parts by weight in relation to 100 parts by weight of the resin composition for satisfying properties such as anti-glare and anti-scintillation functions and for easily controlling the microirregularity shape over the surface of the resin layer and the haze values.

Here, a “refractive index” refers to a value measured according to JIS K-7142. Also, an “average particle size” refers to an average value of diameters of 100 particles as actually measured through an electron microscope.

<Other Layers>

According to the present invention, a polarizing substrate may be layered on the translucent substrate. Also, the polarizing substrate may be layered on that side of the translucent substrate opposite to the layered resin layer. Here, as such a polarizing substrate, light absorption polarizer which transmits certain polarized lights and absorbs other lights or light reflecting polarizer which transmits certain polarized lights and reflects other lights can be used. As light absorption polarizers, films obtained by stretching polyvinyl alcohol, polyvinylene and the like can be used. For example, a polyvinyl alcohol (PVA) film obtained by uniaxially stretching polyvinyl alcohol to which iodine or a dyestuff is adsorbed as a dichroic element may be mentioned. Examples of light reflecting polarizers include DBEF of 3M, composed of several hundreds of alternate layers of two polyester resins (PEN and a PEN copolymer) exhibiting different refractive indices along the direction of draw upon orientation, which are layered and stretched by an extrusion molding technique as well as NIPOCS of Nitto Denko Corporation and Transmax of Merck, Ltd. composed of a cholesteric liquid crystal polymer layer layered with a ¼ wavelength plate, in which an incident light from the side of the cholesteric liquid crystal polymer layer is divided into two circularly polarized lights opposed to each other so that one of the lights may be transmitted and the other may be reflected, and the circularly polarized light transmitted through the cholesteric liquid crystal polymer layer is converted into a linearly polarized light through the ¼ wavelength plate.

Furthermore, a low-reflection layer may preferably be provided on the resin layer in order to enhance contrast. The low-reflection layer is only to be provided on the resin layer, so that examples of layer configurations may include those consisting of a resin layer and a low-reflection layer and those consisting of a translucent substrate, a resin layer and a low-reflection layer. In such a case, the refractive index of the low-reflection layer must be lower than that of the resin layer. Specifically, the refractive index of the low-reflection layer is preferably 1.45 or less. Materials having such characteristics may include inorganic low-reflection materials composed of micronized inorganic materials such as LiF (refractive index n=1.4), MgF₂ (n=1.4), 3NaF.AlF₃ (n=1.4), AlF₃ (n=1.4) and Na₃AlF₆ (n=1.33) that are included in an acrylic resin, epoxy resin and the like as well as organic low-reflection materials such as fluorine-based or silicone-based organic compounds, thermoplastic resins, thermosetting resins and radiation-curable resins. Among them, fluorine-containing materials in particular are preferred for prevention of stains. Also, the low-reflection layer preferably has a interfacial tension of 20 dyne/cm or lower. When the interfacial tension is higher than 20 dyne/cm, stains adhered to the low-reflection layer will be difficult to remove.

Examples of the fluorine-containing materials described above may include vinylidene fluoride-based copolymers, fluoroolefin/hydrocarbon copolymers, fluorine-containing epoxy resins, fluorine-containing epoxy acrylates, fluorine-containing silicones and fluorine-containing alkoxysilanes, which are soluble in organic solvents and easy to handle. These materials can be used alone or in combination.

Also, fluorine-containing methacrylates, such as 2-(perfluorodecyl)ethyl methacrylate, 2-(perfluoro-7-methyloctyl)ethyl methacrylate, 3-(perfluoro-7-methyloctyl)-2-hydroxypropyl methacrylate, 2-(perfluoro-9-methyldecyl)ethyl methacrylate and 3-(perfluoro-8-methyldecyl)-2-hydroxypropyl methacrylate, fluorine-containing acrylates, such as 3-perfluorooctyl-2-hydroxypropyl acrylate, 2-(perfluorodecyl)ethyl acrylate and 2-(perfluoro-9-methydecyl)ethyl acrylate, epoxides, such as 3-perfluorodecyl-1,2-epoxypropane and 3-(perfluoro-9-methyldecyl)-1,2-epoxypropane as well as radiation-curable, fluorine-containing monomers, oligomers and prepolymers such as epoxy acrylates may be mentioned. These materials can be used alone or in combination.

Furthermore, a low-reflection material composed of a sol made of ultrafine silica particles with a size of 5 to 30 nm that are dispersed in water or an organic solvent in mixture with a fluorine-based film former may be used. Examples of sols made of ultrafine silica particles with a size of 5 to 30 nm that are dispersed in water or an organic solvent include known silica sols obtained by condensing an activated silicate, through a process for dealkalizing alkaline metal ions in an alkali silicate through ion exchange or the like or a process for neutralizing an alkali silicate with a mineral acid, known silica sols obtained by hydrolyzing and condensing an alkoxysilane in an organic solvent under the presence of a basic catalyst and organic solvent-based silica sols (organosilica sols) obtained by substituting water in the aqueous silica sols described above with an organic solvent by distillation and the like. These silica sols can be used both in aqueous and organic solvent systems. For producing organic solvent-based silica sols, it is unnecessary to completely substitute water with an organic solvent. The silica sols described above contain 0.5 to 50% by weight of solid content as SiO₂. Configuration of the untrafine silica particles in the silica sols may be varied, such as spherical, needle-shaped and plate-shaped.

Also, as film formers, alkoxysilanes, metal alkoxides, hydrolysates of metal salts, fluorine-modified polysiloxanes and the like may be used. Among the film formers as described above, fluorine-containing compounds may preferably be used in particular because they can suppress adhesion of oils due to a decrease in interfacial tension of the low-reflection layer. The low-reflection layer according to the present invention may be obtained by diluting the materials described above with a solvent for example and applying it on the radiation-curable resin layer by means of a spin coater, a roll coater, printing and the like, followed by drying and then setting it by heat, radiations (when an ultraviolet ray is used, a photopolymerization initiator as described above is used) or the like to cure. Although radiation-curable, fluorine-containing monomers, oligomers and prepolymers are excellent in anti-smudge properties, they are poor in wettability and thus cause problems that the low-reflection layer is repelled when a radiation-curable resin layer is used as the resin layer depending on composition and that the low-reflection layer is delaminated from the resin layer. It is, therefore, desirable to appropriately mix and use monomers, oligomers and prepolymers having polymerizable unsaturated bonds, such as acryloyl series, methacryloyl series, acryloyloxy group and methacryloyl group, as radiation-curable resin compositions to be used for the resin layer.

When plastics-based films that are likely to be damaged by heat, such as PET and TAC, are used for the translucent substrate, radiation-curable resin compositions are preferably selected as materials for these low-reflection layers.

The thickness for low-reflection layers to provide good anti-reflection functions can be calculated according to known equations. When an incident light enters a low-reflection layer orthogonally, the following relationship must only be satisfied as conditions for the low-reflection layer not to reflect the light but to allow the light to be transmitted at 100%. In the equations, Nₒ represents a refractive index of the low-reflection layer, Nₛ represents a refractive index of a resin layer, h represents a thickness of the low-reflection layer and λₒ represents a wavelength of the light.

Nₒ=Nₛ^{1/2} (3) and

Nₒh=λₒ/4 (4)

It will be appreciated that, according to the equation (3) above, in order to prevent the reflection of light by 100%, a material must only be selected such that the refractive-index of the low-reflection layer may be the square root of the refractive index of the underlying layer (resin layer). It is, however, difficult to find a material which fully satisfies this equation and therefore a material which is as close as possible to such a material is to be selected. According to the equation (4) above, the optimum thickness for an antireflection film for the low-reflection layer is calculated based on the refractive index of the low-reflection layer selected according to the equation (3) and on the wavelength of the light. For example, assuming the refractive indices of the radiation-curable resin layer and the low-reflection layer are 1.50 and 1.38 respectively and the wavelength of the light is 550 nm (spectral luminous efficacy), by substituting these values into the equation (4) above, the thickness of the low-reflection layer will be calculated as approximately 0.1 μm and preferably in the range of 0.1±0.01 μm.

Next, the irregularity shape of the anti-glare material according to the preferred embodiment will be described. The irregularity shape of the anti-glare materials can provide an anti-glare material having anti-glare, contrast enhancing and anti-scintillation functions in a balanced manner by a distribution of slope angles of the irregularity shape as given according to American Society of Mechanical Engineers (ASME)/1995 satisfying the equations (1) and (2) below:

A≦0.2 (1) and

0.8≦B≦2.5 (2)

wherein

A=proportion of slope angles at or greater than 1.6° in relation to the total, and B=(proportion of slope angles at or greater than 0.4° and smaller than 1.6° in relation to the total)/(proportion of slope angles smaller than 0.4° in relation to the total).

Regarding A and B, it is preferred that A≦0.1 and 0.9≦B≦1.9 simultaneously. It is more preferred that A≦0.07 and 1.0≦B≦1.7 simultaneously. With 0.2<A, scintillation will unfavorably increase. With either 0.2<A or 2.5<B, light scattering effects on the anti-glare material surfaces will increase, unfavorably rendering images in black whiter and decreasing contrast. In particular, contrast in a bright room (bright room contrast) will notably be impaired. With B<0.8, the light diffusion effects will diminish, decreasing the anti-glare properties.

For the distribution of slope angles of irregularity shape as defined according to the present invention, irregularity shape of an anti-glare material are first measured according to ASME/1995. Next, the height (Y) of irregularity shape is calculated for every 0.5 μm of the measured length (X) for the whole length of irregularity shape measurement to calculate a local slope of the profile (ΔZᵢ) according to the equation:

ΔZᵢ=(dYᵢ₊₃−9×dYᵢ₊₂+45×dYᵢ₊₁−45×dYᵢ₋₁+9×dYᵢ₋₂−dYᵢ₋₃)/(60×dXᵢ)

wherein ΔZᵢ refers to a local slope of the profile at a measurement location d_{Xi}. Then a slope angle (θ) is calculated according to the equation:

θ=tan⁻¹|ΔZᵢ|

After obtaining slope angles (θ) for the whole length of measurement, an frequency distribution was created in increments of 0.1° of slope angles (θ) to give the proportion of those slope angles having the predetermined values defined according to the present invention.

Also, the microirregularity shape have a mean spacing of profile irregularities (Sm) preferably in the range of 50 to 250 μm, more preferably in the range of 55 to 220 μm and even more preferably in the range of 60 to 180 μm. With a mean spacing of profile irregularities greater than 250 μm, scintillation will intensify, while with a mean spacing of profile irregularities smaller than 50 μm, anti-glare properties will deteriorate.

Furthermore, the anti-glare material has a definition of transmitted image preferably in the range of 5.0 to 70.0 (a value measured according to JIS K7105, using a 0.5 mm optical comb) and more preferably in the range of 20.0 to 65.0. With a definition of transmitted image below 5.0, contrast will deteriorate, while with a definition above 70.0, anti-glare properties will deteriorate, making the anti-glare material unsuitable to be used for display surfaces.

When translucent fine particles are contained in the resin layer of the anti-glare material and so on, the anti-glare material preferably has an internal haze value (X) and a total haze value (Y) which satisfy the formulae (5) to (8) below. Here, a “total haze value” herein refers to a haze value of an anti-glare material and an “internal haze value” herein refers to a value obtained by subtracting a haze value of a transparent sheet with pressure-sensitive adhesive from a haze value of an anti-glare material having the transparent sheet over the irregularity shape surface of the anti-glare material. The haze value of the transparent sheet with pressure-sensitive adhesive should preferably be measured before it is applied to the surface of the anti-glare material. Both the haze values refer to those measured according to JIS K7105.

X<Y (5)

Y≦X+35 (6)

5≦Y≦50 (7) and

5≦X≦40 (8)

With either X+35<Y or 50<Y, the surface turns whitish, decreasing contrast, because the light diffusion effects on the surface increase. In particular, contrast in a bright room will be impaired. With either X>Y or X>40, contrast decreases, because the light diffusion effects within the anti-glare material (especially, its optically functional layer) increase. In particular, contrast in a dark room will be impaired. With either Y>X, Y>X+35 or X<5, scintillation may appear, because the light diffusion effects within the anti-glare material diminish.

For use in small to medium size liquid crystal displays of sizes from 10 to 30, the anti-glare material preferably has an internal haze value (X) and a total haze value (Y) which satisfy the formulae (5) and (9) to (11) below:

X<Y (5)

Y≦X+11 (9)

Y≦50 (10) and

15≦X (11)

Also, it is more preferred that X+1<Y<X+8 and 18<X<40 simultaneously. It is particularly preferred that X+2≦Y≦X+6 and 25≦X≦35 simultaneously.

For use in large size liquid crystal displays (TVs) of sizes greater than 30 where high resolution and high contrast are required, the anti-glare material preferably has an internal haze value (X) and a total haze value (Y) which satisfy the formulae (12) and (13) below:

X<Y≦X+7 (12) and

1≦X≦15 (13)

Next, processes for producing anti-glare materials according to the preferred embodiment will be described in detail. First, methods for providing surface irregularity shape as a feature of the present invention will be discussed. Methods for providing surface irregularity shape include those by combining techniques such as extrusion molding, injection molding, emboss processing and nanoimprint and those by coating or printing.

An example of a method by combining techniques is by feeding a raw material composing a translucent material or resin layer through a screw or plunger into a heated cylinder (barrel), fluidizing it by heating, passing it through a die at the tip (mold with a cross-sectional hole for the raw material to pass through) for shaping and drawing it out while pressing a means for emboss processing such as an emboss processing roller or conveyor belt against it, with heating if necessary. A method may also be used by coating a translucent substrate with a resin layer based on a radiation-curable resin or the like and irradiating it with an ultraviolet ray or electron ray for solidification while the coating is covered with an emboss processing film with irregularity shape, by pressing a means for emboss processing such as an emboss processing roller against the formed coating layer with heating if necessary while irradiating an ultraviolet ray or electron ray for solidification, or by applying a resin layer over a releasable (peeling off) substrate having irregularity shape over the releasable surface and irradiating it with an ultraviolet ray or electron ray to produce a solidified and formed transfer sheet and using the sheet to transfer to an object to be transferred such as a translucent substrate. A method using an emboss processing means such as an emboss processing roller is preferred to a method using a consumable member such as an emboss processing film because it is advantageous in terms of running costs. When the translucent substrate contains an ultraviolet ray absorbing agent, the ultraviolet ray should desirably be irradiated from the side of the resin layer.

An example of a method by coating or printing is by coating or printing a translucent substrate with a coating material having translucent fine particles dispersed in a resin matrix through a conventional coating or printing process, followed by drying and curing to provide a resin layer having microirregularity shape over the surface, however with no particular limitation thereto. Specific examples of coating and printing procedures may include coating, such as airdoctor coating, bar coating, blade coating, knife coating, reverse-roll coating, transfer roll coating, gravure roll coating, kiss coating, cast coating, spray coating, slot orifice coating, calendar coating, dam coating, dip coating and die coating as well as intaglio printing, such as gravure printing and stencil printing, such as screen printing.

Next, methods for controlling various parameters as features of the present invention such as surface irregularity shape and haze values will be discussed in detail. First, processes for forming surface irregularity shape may largely be divided into those by pressing a replica such as an emboss processing roll or emboss processing film against a surface to be provided with irregularity shape to transfer the form as described above and those by providing a resin layer containing translucent fine particles on a translucent substrate. For the former case, control may be made by selecting photomasks and adjusting etching conditions, using conventional photolithography techniques, for example. For the latter case, adjustment may be made through addition amount of the translucent fine particles (content per unit area), coating layer thickness, physical properties of the coating material and drying conditions. Use of a viscous agent as a material can suppress sedimentation of the fine particles to allow easy adjustment for the location of the fine particles along the thickness direction. Adjustment for bringing X (internal haze) and Y (total haze) within the ranges defined in the present invention is enabled by controlling parameters described above, such as differences in refractive index between the translucent fine particles contained in the resin layer and the resin matrix, content of the translucent fine particles and drying conditions.

### Present Invention (2)

First, each component of an optical layered product according to the preferred embodiment will be described in detail. The optical layered product according to the preferred embodiment indispensably comprises at least an optically functional layer containing translucent fine particles (translucent organic filler) provided on one or both sides of a translucent substrate. Further, the optical layered product according to the preferred embodiment may comprise a low-reflection layer, anti-smudge layer, antistatic layer, infrared ray reflection (NIR) layer (infrared ray cutting layer) and polarizing layer on the optical layered product or between the translucent substrate and the optical layered product. Description will be made below first on the indispensable translucent substrate and optically functional layer and then on the optional layers.

<Translucent Substrate>

First, the translucent substrates according to the preferred embodiment are not particularly limited as long as they are translucent. Glasses such as quartz glass and soda glass may be used. However, various resin films of PET, TAC, polyethylene naphthalate (PEN), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymers (COC), norbornene-containing resins, polyether sulfone, cellophane, aromatic polyamides and the like may preferably be used. For use in PDPs and LCDs, films of PET and TAC are more preferred.

The transparency of such translucent substrates is preferably as high as possible. The total transmittance (JIS K7105) of the substrates is preferably 80% or higher and more preferably 90% or higher. The thickness of the translucent substrates is preferably smaller in view of weight saving. In consideration of productivity and ease of handling, however, substrates having a thickness in the range of 1 to 700 μm and preferably in the range of 25 to 250 μm are preferably used.

Also, the adherence between the translucent substrate and the optically functional layer can be enhanced by subjecting the translucent substrate to surface treatment such as alkali treatment, corona treatment, plasma treatment and sputtering and/or surface modification treatment such as application of surfactants, silane coupling agents or the like or Si vapor deposition. Therefore, scratch resistance of the optically functional layer can be enhanced.

<Translucent Resin>

Next, the optically functional layer according to the preferred embodiment will be described in detail. The optically functional layer according the preferred embodiment is composed of a translucent resin in which translucent fine particles (translucent organic filler) and metal oxide fine particles are dispersed. Here, a “translucent resin” is the total solid content minus the translucent fine particles in a coating material (matrix component). The translucent resin is preferably formed by curing an energy-curable resin by an energy such as heat or a radiation and is more preferably formed by curing a radiation-curable resin composition by a radiation, however with no limitation thereto. Here, radiation-curable resin compositions composing the translucent resin include monomers, oligomers and prepolymers having radically polymerizable functional groups such as acryloyl, methacryloyl, acryloyloxy and methacryloyloxy groups or cationically polymerizable functional groups such as epoxy, vinyl ether and oxetane groups. Such monomers, oligomers and prepolymers can be used alone or in combination as appropriate. Examples of monomers may include methyl acrylate, methyl methacrylate, methoxy polyethylene methacrylate, cyclohexyl methacrylate, phenoxyethyl methacrylate, ethylene glycol dimethacrylate, dipentaerythritol hexaacrylate, trimethylolpropane trimethacrylate and pentaerythritol triacrylate. Examples of oligomers and prepolymers may include acrylate compounds such as polyester acrylates, polyurethane acrylates, multifunctional urethane acrylates, epoxy acrylates, polyether acrylates, alkyd acrylates, melamine acrylates and silicone acrylates, unsaturated polyesters, epoxy-based compounds such as tetramethylene glycol diglycidyl ether, propylene glycol diglycidyl ether, neopentyl glycol diglycidyl ether, bisphenol-A diglycidyl ether and various cycloaliphatic epoxies as well as oxetane compounds such as 3-ethyl-3-hydroxymethyl oxetane, 1,4-bis-{[(3-ethyl-3-oxetanyl)methoxy]methyl}benzene and di[1-ethyl-(3-oxetanyl)]methyl ether. Such oligomers and prepolymers can be used alone or in combination.

The radiation-curable resin compositions can be cured as such by irradiation with electron rays. When they are cured by irradiation with ultraviolet rays, however, addition of photopolymerization initiators will be needed. Radiations to be used may be ultraviolet rays, visible lights, infrared rays or electron rays. Also, these radiations may be polarized or non-polarized. Examples of photopolymerization initiators include radical polymerization initiators, such as acetophenones, benzophenones, thioxanthones, benzoin and benzoin methyl ether as well as cationic polymerization initiators, such as aromatic diazonium salts, aromatic sulfonium salts, aromatic iodonium salts and metallocene compounds. Such photopolymerization initiators can be used alone or in combination as appropriate.

According to the preferred embodiment, polymeric resins may be added to the radiation-curable resin compositions to such an extent that the polymerization curing may not be prevented. Such polymeric resins are thermoplastic resins soluble in organic solvents to be used for coating materials for resin layers to be subsequently referred to, specific examples of which may include acrylic resins, alkyd resins, polyester resins, cellulose or cellulose derivatives. Such resins preferably contain acidic functional groups such as carboxyl, phosphoric and sulfonic groups.

Also, additives such as leveling agents, viscous agents and antistatic agents may be contained in the radiation-curable resin compositions. The leveling agents work to equalize the surface tension of coatings to repair any defects before formation of coatings. Substances lower in both interfacial tension and surface tension than the radiation-curable resin compositions described above are used as leveling agents. The viscous agents work to impart thixotropy to the radiation-curable resin compositions described above and are effective in formation of microirregularity shape over the surface of resin layers due to the prevention of translucent fine particles, pigments and the like from precipitation. Viscous agents are not particularly limited, use of synthetic mica being preferred for example. Further, it is preferred to organically treat the surface of the viscous agents with a quaternary ammonium salt or the like. Such treatment can increase affinity with resins or metal oxide compounds, improve performances and also improve processability.

The translucent resin in the optically functional layer is mainly composed of a cured product of the radiation-curable resin composition described above. The process for forming it involves coating a coating material comprising the radiation-curable resin composition and an organic solvent and volatilizing the organic solvent, before curing by irradiating with an electron ray or ultraviolet ray. Specifically, solvents selected from alcohols, esters, ketones, ethers and aromatic hydrocarbons may be used alone or in combination, in consideration of coatabilities such as wettability toward translucent substrates, viscosity and drying rate.

<Dispersed Components>

Next, the translucent organic filler and the metal oxide fine particles indispensably contained according to the preferred embodiment will be described in detail. According to the preferred embodiment, the metal oxide fine particles are unevenly distributed toward (sprinkled over) the surface of the translucent organic filler. Having such a configuration can increase the scratch resistance of the optical layered product. The term “uneven distribution” as used herein and in the claims means that the metal oxides are present in a manner unevenly distributed specifically toward the surface of the translucent organic filler. The number of metal oxide fine particles per μm of the peripheral length of the cross section of the translucent organic filler observed around the cross section near the center of the translucent organic filler, observing the cross section of the optically functional layer through TEM ([number of metal oxide fine particles observed around the cross section (on the surface) of the translucent organic filler)]/[peripheral length of the cross section of translucent organic filler]) is preferably 2 or more per μm, more preferably 5 or more per μm and even more preferably 10 or more per μm. The upper limit is not particularly defined, and is 100 or less per μm, for example. The number of fine particles described above is the average of numbers at the cross section of randomly selected ten fine particles.

Translucent Organic Filler

As a translucent organic filler to be contained in the optically functional layer, organic translucent fine particles composed of acrylic resins, polystyrene resins, styrene-acrylic copolymers, polyethylene resins, epoxy resins, silicone resins, polyvinylidene fluoride, polyethylene fluoride and the like may be used, for example.

The translucent organic filler contained in the optically functional layer has a difference in refractive index from the radiation-curable translucent resin layer of preferably 0.05 or less, more preferably 0.03 or less and even more preferably 0.01 or less. When the difference in refractive index between the radiation-curable translucent resin layer and the translucent organic filler is greater than 0.05, the degree of light scattering will be too great, decreasing the contribution to contrast enhancement. The refractive index of the translucent organic filler is preferably from 1.45 to 1.58 and more preferably from 1.50 to 1.57. A “refractive index” means a value measured according to JIS K-7142.

Next, the translucent organic filler has a particle size of preferably 0.3 to 10 μm and more preferably 1 to 5 μm. When the particle size is smaller than 0.3 μm, anti-glare properties will unfavorably decrease and, when the particle size is greater than 10 μm, scintillation will occur and the degree of surface irregularity shape will be so great that the surface may unfavorably turn whitish. Further, the particle size of the translucent organic filler is preferably from 20 to 80% in relation to the film thickness and is more preferably from 30 to 70% in relation to the film thickness. A “particle size” refers to an average value of diameters of 100 particles as actually measured through an electron microscope. Among the total number of particles, finely divided powders and rough particles entrained in a process for producing the fine particles comprise less than 5% (more preferably less than 1%). Proportions of the translucent fine particles in the translucent resin are not particularly limited, but are preferably from 1 to 50% by weight and more preferably from 5 to 10% by weight of the solid content of the optical functional layer. Within such ranges, it is preferable in satisfying properties such as anti-glare and anti-scintillation functions and it is easy to control the microirregularity shape over the surface of the optically function layer and the light diffusion.

Metal Oxide Fine Particles

Subsequently, examples of metal oxide fine particles to be contained in the optically functional layer include alumina fine particles, zirconia fine particles, titania fine particles, aluminum hydroxide fine particles, tin oxide fine particles, zinc oxide and cesium oxide. These fine particles may preferably be coated with a resin. Also, the metal oxide fine particles may preferably be used as metal oxide sols, such as alumina sol, zirconia sol, titania sol, aluminum hydroxide sol and tin oxide sol. Among them, alumina sol is particularly preferred.

The metal oxide fine particles to be contained in the optically functional layer may in principle have any refractive indices because they have notably small particle sizes and have little optical influences.

Next, the metal oxide fine particles have particle sizes of preferably 1 to 100 nm and more preferably 5 to 50 nm. When the particle sizes are 1 nm or less, the production costs for the metal oxide fine particles and metal oxide sols will increase. Also, during formation of the optically functional layer, the metal oxide fine particles and the metal oxide sols will lose mobility in the layer, causing such a problem that uneven distribution will be difficult to occur. Also, when the particle sizes are 100 nm or greater, haze will increase to impair optical characteristics of the optical layered product such as by lowering transmission and contrast. Here, a “particle size” refers to an average value of diameters of 100 particles as actually measured through an electron microscope. Among the total number of particles, finely divided powders and rough particles entrained in a process for producing the fine particles comprise less than 5% (more preferably less than 1%). Mix proportions of the metal oxide fine particles are necessarily from 0.1 to 10% by weight, preferably from 0.3 to 5.0% by weight and more preferably from 0.5 to 3.0% by weight of the solid content of the optically functional layer. When the mix proportions are less than the ranges described above, scratch resistance will decrease and, when they exceed the ranges, optical properties will be compromised as described above.

Increasing affinity between the translucent organic filler and the metal oxide fine particles can facilitate the uneven distribution efficiently, providing high scratch resistance with small mix proportions. An example of a method for increasing affinity is by using a translucent organic filler copolymerized with a monomer having functional groups such as carboxyl or OH groups. Also, surface modification treatment may also be carried out. Such surface modification treatment will subsequently be referred to. Alternatively, a method may be used in which an intermediate agent having affinity to both the translucent organic filler and the metal oxide fine particles is added. In such a case, intermediate agents, such as synthetic mica, nonionic surfactants, anionic surfactants and leveling agents (fluorine-based, for example) may be used. Here, contents of intermediate agents are preferably from 0.1 to 10% by weight and more preferably from 0.2 to 0.5% by weight of the solid content of the optically functional layer.

<Surface Modification Treatment>

Next, surface modification treatment will be described in detail. Processes for producing metal oxide fine particles to be used here are not particularly limited. The metal oxide fine particles may be obtained by optional processes including gas phase method, sol-gel process, colloidal precipitation method, oxidation method with molten metal spray and arc discharge.

After preparing predetermined metal oxide fine particles as described above, it is preferred to carry out surface modification treatment to the metal oxide fine particles using a surface modifier. The surface modification treatment is carried out by dispersing the metal oxide fine particles in a predetermined solvent, such as organic solvent, to which the surface modifier is added, to effect a condensation reaction. In so doing, the solution provided to the surface modification may appropriately be heated at a temperature at or lower than the boiling point of the solvent, or in dispersion mixing, such procedures as ultrasonic waves, microbead milling, agitation and high-pressure emulsification may be used. Also, depending on the scale of production, a magnetic stirrer or a motor with mixing blades may optionally be used for agitation. The surface modifier may be diluted in advance using an organic solvent.

The surface modifiers are not particularly limited, examples of which may include organometallic compounds, such as silane coupling agents, silylating agents, titan coupling agents, alkyl lithium and alkyl aluminum. Among them, silane coupling agents and silylating agents are particularly preferred in view of ease of use and costs. Mix proportions of the surfactants are preferably from 0.1 to 10% by weight of the solid content of the metal oxide fine particles or the metal oxide sol. At less than 0.1%, effects are slim while, at more than 10.0%, stability when rendered coatable is compromised.

Silane coupling agents are silane compounds having a structure that, to hydrolyzable silyl groups having affinity or reactivity to inorganic materials, organic substituent groups having affinity or reactivity to organic substances are chemically bonded. Examples of hydrolyzable groups bonded to silicon may include alkoxy, halogen, acetoxy and alkenoxy groups, alkoxy groups, in particular, methoxy and ethoxy groups being typically used.

Examples of organic substituent groups as described above may include alkyl, aryl, amino, methacryl, acryl, vinyl, epoxy and mercapto groups. Specific examples may include alkyltrichlorosilane, alkyltrialkoxysilane, alkyldialkoxychlorosilane, dialkylalkoxychlorosilane, trialkylchlorosilane, trialkylalkoxysilane, aryltrichlorosilane, aryltrialkoxysilane, diaryldichlorosilane, diaryldialkoxysilane, triarylchlorosilane, triarylalkoxysilane, γ-aminopropyltrialkoxysilane, γ-aminopropylmethyldialkoxysilane, γ-ureidopropyltrialkoxysilane, γ-methacryloxypropyltrialkoxysilane, vinyltrialkoxysilane, vinyltriacetoxysilane, vinyltrichlorosilane, γ-glycidoxypropyltrialkoxysilane, γ-glycidoxypropylmethyldialkoxysilane, (3,4-epoxycyclohexyl)ethyltrialkoxysilane, γ-mercaptopropyltrialkoxysilane and γ-chloropropyltrialkoxysilane.

Examples of silylating agents may include trimethylsilylating agents, alkylsilanes and allylsilanes. Examples of trimethylsilylating agents may include trimethylchlorosilane, hexamethyldisilazane, n-trimethylsilylimidazole, bis(trimethylsilyl)urea, trimethylsilylacetoamide, bistrimethylsilylacetoamide, trimethylsilylisocyanate, trimethylmethoxysilane and trimethylethoxysilane. Examples of alkylsilanes may include 1,6-bis(trimethoxysilyl)hexane, dimethylsilyldiisocyanate and methylsilyltriisocyanate. Examples of allylsilanes may include phenylsilyltriisocyanate.

Also, solvents excellent for dispersion of the metal oxide fine particles and dissolution of the surfactants may preferably used as the solvents described above. When solvents poor in dispersibility are used, the metal oxide fine particles will cohesiveness and, when solvents poor in solubility are used, the modification agents will separate. Specifically, solvents may appropriately be selected for use among the solvents used for preparing the organosols described above.

<Removal of Free Modification Agent and Purification>

Next, after the surface modification treatment is complete, the solvent in which the metal oxide fine particles still remain will directly be washed for purification to remove free modification agent not contributing to the surface modification that is chemically attached to the surface of the metal oxide fine particles. According to the present invention, the solvent is directly washed to remove the free modification agent, without administering such a procedure as drying or solid-liquid separation to the solvent in which the metal oxide fine particles still remain. Thus, the free modification agent can efficiently be removed for purification.

<Configuration of Optically Functional Layer>

The optically functional layer has a thickness in the range of preferably 3 to 25 μm, more preferably 5 to 15 μm and even more preferably 6 to 12 μm. When the thickness is smaller than 3 μm, particles with different specific gravities may not sufficiently be separated in the thickness direction. When the thickness is greater than 25 μm, curing shrinkage of the optically functional layer may cause curls, microcracks, a decrease in adhesion in relation to the translucent substrate or a decrease in translucency. It may also cause a cost increase due to an increase in coating material needed in association with an increase in film thickness.

<Low-Reflection Layer>

According to the preferred embodiment, a low-reflection layer may be provided on the optically functional layer in order to enhance contrast. In such a case, the refractive index of the low-reflection layer must be lower than that of the optically functional layer and is preferably 1.45 or less. Materials having such characteristics may include inorganic low-reflection materials composed of micronized inorganic materials such as LiF (refractive index n=1.4), MgF₂ (n=1.4), 3NaF.AlF₃ (n=1.4), AlF₃ (n=1.4) and Na₃AlF₆ (n=1.33) that are included in an acrylic resin, epoxy resin and the like as well as organic low-reflection materials such as fluorine-based or silicone-based organic compounds, thermoplastic resins, thermosetting resins and radiation-curable resins. Among them, fluorine-containing materials in particular are preferred for prevention of stains. Also, the low-reflection layer preferably has a interfacial tension of 20 dyne/cm or lower. When the interfacial tension is higher than 20 dyne/cm, stains adhered to the low-reflection layer will be difficult to remove.

Examples of the fluorine-containing materials described above may include vinylidene fluoride-based copolymers, fluoroolefin/hydrocarbon copolymers, fluorine-containing epoxy resins, fluorine-containing epoxy acrylates, fluorine-containing silicones and fluorine-containing alkoxysilanes, which are soluble in organic solvents and easy to handle. These materials can be used alone or in combination.

Also, fluorine-containing methacrylates, such as 2-(perfluorodecyl)ethyl methacrylate, 2-(perfluoro-7-methyloctyl)ethyl methacrylate, 3-(perfluoro-7-methyloctyl)-2-hydroxypropyl methacrylate, 2-(perfluoro-9-methyldecyl)ethyl methacrylate and 3-(perfluoro-8-methyldecyl)-2-hydroxypropyl methacrylate, fluorine-containing acrylates, such as 3-perfluorooctyl-2-hydroxypropyl acrylate, 2-(perfluorodecyl)ethyl acrylate and 2-(perfluoro-9-methydecyl)ethyl acrylate, epoxides, such as 3-perfluorodecyl-1,2-epoxypropane and 3-(perfluoro-9-methyldecyl)-1,2-epoxypropane as well as radiation-curable, fluorine-containing monomers, oligomers and prepolymers such as epoxy acrylates may be mentioned. These materials can be used alone or in combination.

Furthermore, a low-reflection material composed of a sol made of ultrafine silica particles with a size of 5 to 30 nm that are dispersed in water or an organic solvent in mixture with a fluorine-based film former may be used. Examples of sols made of ultrafine silica particles with a size of 5 to 30 nm that are dispersed in water or an organic solvent include known silica sols obtained by condensing an activated silicate, through a process for dealkalizing alkaline metal ions in an alkali silicate through ion exchange or the like or a process for neutralizing an alkali silicate with a mineral acid, known silica sols obtained by hydrolyzing and condensing an alkoxysilane in an organic solvent under the presence of a basic catalyst and organic solvent-based silica sols (organosilica sols) obtained by substituting water in the aqueous silica sols described above with an organic solvent by distillation and the like. These silica sols can be used both in aqueous and organic solvent systems. For producing organic solvent-based silica sols, it is unnecessary to completely substitute water with an organic solvent. The silica sols described above contain 0.5 to 50% by weight of solid content as SiO₂. Configuration of the untrafine silica particles in the silica sols may be varied, such as spherical, needle-shaped and plate-shaped.

Also, as film formers, alkoxysilanes, metal alkoxides, hydrolysates of metal salts, fluorine-modified polysiloxanes and the like may be used. Among the film formers as described above, fluorine-containing compounds may preferably be used in particular because they can suppress adhesion of oils due to a decrease in interfacial tension of the low-reflection layer. The low-reflection layer according to the present invention may be obtained by diluting the materials described above with a solvent for example and applying it on the radiation-curable resin layer by means of a spin coater, a roll coater, printing and the like, followed by drying and then setting it by heat, radiations (when an ultraviolet ray is used, a photopolymerization initiator as described above is used) or the like to cure. Although the radiation-curable, fluorine-containing monomers, oligomers and prepolymers are excellent in anti-smudge properties, they are poor in wettability and thus cause problems that the low-reflection layer is repelled on the radiation-curable resin layer depending on composition and that the low-reflection layer is delaminated from the radiation-curable resin layer. Therefore, it is desirable to appropriately mix and use the monomers, oligomers and prepolymers having polymerizable unsaturated bonds, such as acryloyl series, methacryloyl series, acryloyloxy group and methacryloyl group, described as the radiation-curable resins mentioned above to be used for the radiation-curable resin layer.

When plastics-based films that are likely to be damaged by heat, such as PET and TAC, are used for the translucent substrate, radiation-curable resin compositions are preferably selected as materials for these low-reflection layers.

The thickness for low-reflection layers to provide good anti-reflection functions can be calculated according to known equations. When an incident light is enters a low-reflection layer orthogonally, the following relationship must only be satisfied as conditions for the low-reflection layer not to reflect the light but to allow the light to be transmitted at 100%. In the equations, Nₒ represents a refractive index of the low-reflection layer, Nₛ represents a refractive index of a radiation-curable resin layer, h represents a thickness of the low-reflection layer and λₒ represents a wavelength of the light.

Nₒ=Nₛ^{1/2} (1) and

Nₒh=λₒ/4 (2)

It will be appreciated that, according to the equation (1) above, in order to prevent the reflection of light by 100%, a material must only be selected such that the refractive index of the low-reflection layer may be the square root of the refractive index of the underlying layer (radiation-curable resin layer). It is, however, difficult to find a material which fully satisfies this equation and therefore a material which is as close as possible to such a material is to be selected. According to the equation (2) above, the optimum thickness for an antireflection film for the low-reflection layer is calculated based on the refractive index of the low-reflection layer selected according to the equation (1) and on the wavelength of the light. For example, assuming the refractive indices of the radiation-curable resin layer and the low-reflection layer are 1.50 and 1.38 respectively and the wavelength of the light is 550 nm (spectral luminous efficacy), by substituting these values into the equation (2) above, the thickness of the low-reflection layer will be calculated as approximately 0.1 μm and preferably in the range of 0.1±0.01 μm.

<Anti-Smudge Layer>

The optical layered product according to the preferred embodiment can be provided with an anti-smudge layer on the optically functional layer. The anti-smudge layer contains at least a perfluoroalkyl ether compound, which functions as an anti-smudge component providing substantial anti-smudge properties. Compounds containing perfluoroalkyl ether groups are used as appropriate. Among them, those having at a terminal thereof one or more functional groups having high affinity with a silica film to be subsequently referred to and/or one or more functional groups capable of chemical bonding with the silica film are preferred. The perfluoroalkyl ether compounds to be used can be used alone or in combination. Furthermore, molecular weights of these compounds are preferably from 500 to 10,000 and more preferably from 500 to 4,000. Those with molecular weights of 500 or less can not provide sufficient anti-smudge properties and durability, while those with molecular weights of 10,000 or more have decreased solubility in solvents to have difficulty in forming uniform anti-smudge layers.

<Antistatic Layer>

The optical layered product according to the preferred embodiment can be provided with an antistatic layer over and below the optically functional layer (between the optically functional layer and the translucent substrate). The antistatic layer can be provided by such processes as vapor-depositing or sputtering an extremely thin film of a metal, such as aluminum and tin or a metal oxide, such as ITO, solvent-coating dispersions of fine particles or whiskers of aluminum, tin or the like, fine particles or whiskers of metal oxides, such as tin oxide doped with antimony or the like, or of a filler of a charge transfer complex made of 7,7,8,8-tetracyanoquinodimethane and electron donors such as metal ions or organic cations (donor) in a polyester resin, acrylic resin or epoxy resin or the like, and solvent-coating polypyrroles, polyanilines or the like doped with camphor sulfonic acid or the like. The transmission of the antistatic layer is preferably 80% or higher for optical applications.

<Near Infrared Ray Cutting Layer>

The optical layered product according to the preferred embodiment can be provided with a near-infrared ray cutting layer over and below the optically functional layer (between the optically functional layer and the translucent substrate). The near-infrared ray cutting layer can be formed by inclusion of a near-infrared ray cut dye. A near-infrared ray cut dye is a dye having maximum absorption value in relation to a near-infrared ray having a wavelength of 780 nm or higher. Examples include phthalocyanine dyes, aluminum dyes, anthraquinone dyes, naphthalocyanine dyes, dithiol complex dyes, polymethine dyes, pyrylium dyes, thiopyrylium dyes, squarilium dyes, chloconium dyes, azulenium dyes, tetradehydrocholine dyes, triphenylmethane dyes and diimmonium dyes. These dyes can be used alone or in combination. Specific examples of near-infrared ray cut dyes include EXCOLOR 802K, EXCOLOR 803K and EXCOLOR 814K (trade names of Nippon Shokubai Co., Ltd.), IR-750, IRG-002, IRG-003, IRG-022, IRG-023, IRG-820, CY-2, CY-4, CY-9 and CY-20 (trade names of Nippon Kayaku Co., Ltd.) and PA-001, PA-1005, PA-1006, SIR-114, SIR-128, SIR-130 and SIR-159 (trade names of Mitsui Chemicals, Inc.).

<Polarizing Layer>

The optical layered product according to the preferred embodiment can also be rendered a polarizing film. In this case, such a polarizing film has a configuration in which at least an optically functional layer (layer having an area dispersion variability within a predetermined range, as mentioned above) containing transparent fine particles is provided directly or via another layer on one side of a first protective material and a second protective material is layered via a polarizing layer to the opposite side from the surface layer. As such a polarizing layer, light absorption polarizer which transmits certain polarized lights and absorbs other lights or light reflecting polarizer which transmits certain polarized lights and reflects other lights can be used. As light absorption polarizers, films obtained by stretching polyvinyl alcohol, polyvinylene and the like can be used. For example, a polyvinyl alcohol (PVA) film obtained by uniaxially stretching polyvinyl alcohol to which iodine or a dyestuff is adsorbed as a dichroic element may be mentioned. Examples of light-reflecting polarizers include DBEF of 3M, composed of several hundreds of alternate layers of two polyester resins (PEN and a PEN copolymer) exhibiting different refractive indices along the orientation direction upon orientation, which are layered and stretched by an extrusion molding technique as well as NIPOCS of Nitto Denko Corporation and Transmax of Merck, Ltd. composed of a cholesteric liquid crystal polymer layer layered with a ¼ wavelength plate, in which an incident light from the side of the cholesteric liquid crystal polymer is divided into two circularly polarized lights opposed to each other so that one of the lights may be transmitted and the other may be reflected, and the circularly polarized light transmitted through the cholesteric liquid crystal polymer layer is converted into a linearly polarized light through the ¼ wavelength plate.

Furthermore, the optical layered product has a definition of transmitted image preferably in the range of 5.0 to 70.0 (a value measured according to JIS K7105, using a 0.5 mm optical comb) and more preferably in the range of 20.0 to 65.0. With a definition of transmitted image below 5.0, contrast will degrade while above 70.0, anti-glare properties will degrade, making it unsuitable as an optical layered product to be used for display surfaces.

The optical layered product preferably has an internal haze value (X) and a total haze value (Y) which satisfy the formulae (1) to (4) below. Here, a “total haze value” refers to a haze value of an optical layered product and an “internal haze value” refers to a value obtained by subtracting a haze value of a transparent sheet with pressure-sensitive adhesive from a haze value of an optical layered product having the transparent sheet over the microirregularity shape surface of the optical layered product. Both the haze values refer to those measured according to JIS K7105.

Y>X (1)

Y≦X+7 (2)

X≦15 (3) and

X≧1 (4)

Within the range of Y>X+7, X≦15 and X≧1, the surface becomes whitish, decreasing contrast, because light diffusion effects on the surface increase. In particular, contrast in a bright room will be impaired. Within the range of Y>X, Y≦X+7 and X>15, light diffusion effects in the optical layered product (in particular, in the optically functional layer) will increase, decreasing contrast. In particular, contrast in a dark room will be impaired. Within the range of Y>X, X<1 and Y≦X+7, scintillation may appear, because the light diffusion effects within the optical layered product diminish. A preferred range is Y>X, Y≦X+7 and 3<X≦15.

<Properties of Optical Layered Product>

Next, properties of the optical layered product according to the preferred embodiment will be described in detail. The optical layered product according to the preferred embodiment has scratch resistance as follows. Since the surface of the translucent organic filler is protected by the metal oxide fine particles, the filler is rigid and tough. Also, since coating adhesion between the filler and the resin is increased, the resin on the filler (raised portions on the surface of the optically functional layer) may be more durable against scraping.

<Process for Production>

Next, a process for producing the optical layered product according to the preferred embodiment will be described in detail. First, a process for producing the optically functional layer of the optical layered product according to the preferred embodiment will be described. The optically functional layer is not particularly limited and a desired one can be obtained, for example, by adding a metal oxide sol to a premix of a translucent resin composition, translucent organic filler, a solvent, a leveling agent and a viscous agent and agitating it with a disper or the like to prepare a coating material, which is applied to a transparent substrate, which is then dried using a dryer and irradiated with a UV radiation. In so doing, affinity provided by any of the procedures described above between the translucent organic filler and the metal oxide fine particles can unevenly distribute the metal oxide fine particles toward the surface of the translucent organic filler. The viscosity of the coating material suitable for uneven distribution is from 10 to 2,000 cP. The temperature for drying suitable for uneven distribution is from 50 to 130° C. The drying rate suitable for uneven distribution is relatively low, ranging from 10 to 50 m per minute. Also, it is preferred to provide a predrying step immediately after applying the prepared coating material to the transparent substrate to form a coated film and before the step of drying with a dryer. The drying of the coated film may thereby be carried out more slowly so is that the metal oxide fine particles may more easily be unevenly distributed toward the surface of the translucent organic filler. The predrying step means a step of uniformly blowing a gentle stream of air to the coated film from the direction approximately normal (vertical) to the plane of the coated film. The flowrate of the gentle stream of air is preferably from 0.01 to 1.0 m per second. The flowrate may be measured using an air velocity meter (KANOMAX Climomaster™) with an air velocity sensing aperture spaced 1 cm from the coated film. Also, the temperature of the stream of air during the predrying step may be set at 20 to 60° C.

Other compositions of the optical layered product according to the preferred embodiment can be produced by conventional processes for producing optical layered products. For example, processes for forming the optically functional layer on the translucent substrate are not particularly limited. An example is by applying a coating material containing radiation-curable resin composition containing translucent fine particles to a translucent substrate, followed by drying and curing to provide an optically functional layer having microirregularity shape over the surface. Examples of procedures for coating a translucent substrate with a coating material include conventional coating and printing methods. Specific examples may include coating, such as airdoctor coating, bar coating, blade coating, knife coating, reverse-roll coating, transfer roll coating, gravure roll coating, kiss coating, cast coating, spray coating, slot orifice coating, calendar coating, dam coating, dip coating and die coating as well as intaglio printing, such as gravure printing and stencil printing, such as screen printing.

### EXAMPLES

Examples of the present invention (1) and comparative examples will be illustrated below.

### Example 1

The resin layer components listed in Table 1 for Example 1 were agitated with a disper for one hour and applied by die head coating method to one side of a translucent substrate made of a TAC film 80 μm in thickness (total transmittance 92%). After drying at 100° C. for one minute, the film was abutted against the surface of an emboss processing roll (surface fluorine treatment) provided with irregularity shape through photolithography so that the distribution of slope angles may show A=0.1 and B=1.0, nipping with a back-up roll so that the coated surface may entirely contact the surface, immediately followed by ultraviolet irradiation using a 160 W metal halide lamp from the side of the translucent substrate (irradiation distance 10 cm, irradiation time 30 seconds) while the coated surface was in contact with the emboss processing roll. Subsequently, ultraviolet irradiation was carried out to that side of the resin layer having the irregularity shape in nitrogen atmosphere under similar conditions as described above, to completely cure the coated film to form a resin layer. In this manner, the anti-glare material of Example 1 was obtained.

### Examples 2 and 3 and Comparative Examples 1 to 3

A coating material obtained by dispersing resin layer components containing the translucent fine particles listed in Table 1 for Examples 2 and 3 and Comparative Examples 1 to 3 for one hour in a sandmill was applied by reverse-roll coating method to one side of a translucent substrate made of a TAC film 80 μm in thickness (total transmittance 92-6). After drying at 100° C. for one minute, ultraviolet irradiation was carried out in a nitrogen atmosphere using a 160 W/cm, beam-condensing, high-pressure mercury vapor lamp (irradiation distance 15 cm, irradiation time 30 seconds) to cure the coated film to form a resin layer. In this manner, the anti-glare materials of Examples 2 and 3 and Comparative Examples 1 to 3 were obtained.

Refractive indices for coating materials for resin layer shown in Table 1 are values from raw materials and refractive indices after curing are likely to vary typically by 0.01 to 0.03.

TABLE 1

| | resin layer | | | | |
|---|---|---|---|---|---|
| | components | manufacturers | trade names | RIs | pbw |
| Ex. 1 | polyfunctional | Shin-Nakamura | A-TMM-3L | 1.49 | 61.0 |
| | acrylate | Chemical Co., | | | |
| | | Ltd. | | | |
| | polyfunctional | Kyoeisha | UA-306H | 1.51 | 29.5 |
| | urethane-based | Chemical Co., | | | |
| | acrylate | Ltd. | | | |
| | photoinitiator | Ciba | Irgacure-184 | | 4.0 |
| | | Specialty | | | |
| | | Chemicals | | | |
| | | Inc. | | | |
| | crosslinked | Soken | SX-130 | 1.59 | 5.0 |
| | polystyrene: | Chemical & | | | |
| | particle size | Engineering | | | |
| | 1.3 μm | Co., Ltd. | | | |
| | leveling agent | BYK Japan KK | BYK-323 | | 0.5 |
| | solvent | | MEK | | 40.0 |
| Ex. 2 | polyfunctional | Nippon | UV7600B | 1.50 | 81.5 |
| | acrylate | Synthetic | | | |
| | | Chemical | | | |
| | | Industry Co., | | | |
| | | Ltd. | | | |
| | crosslinked | Sekisui | MBX-5 | 1.49 | 4.0 |
| | PMMA: particle | Plastics Co., | | | |
| | size 5.0 μm | Ltd. | | | |
| | urea | Ciba | Pergopak M-2 | 1.58 | 4.0 |
| | formaldehyde: | Specialty | | | |
| | particle size | Chemicals | | | |
| | 5.5 μm | Inc. | | | |
| | photoinitiator | Ciba | Irgacure-907 | | 4.5 |
| | | Specialty | | | |
| | | Chemicals | | | |
| | | Inc. | | | |
| | leveling agent | BYK Japan KK | BYK-323 | | 0.5 |
| | CAP | Eastman | CAP 482-20 | | 5.5 |
| | | Chemical | | | |
| | | Japan Ltd. | | | |
| | solvent | | MEK | | 90.0 |
| | solvent | | MIBK | | 10.0 |
| Ex. 3 | polyfunctional | Nippon | UV7600B | 1.50 | 83.5 |
| | acrylate | Synthetic | | | |
| | | Chemical | | | |
| | | Industry Co., | | | |
| | | Ltd. | | | |
| | crosslinked | Sekisui | MBX-5 | 1.49 | 3.0 |
| | PMMA: particle | Plastics Co., | | | |
| | size. 5.0 μm | Ltd. | | | |
| | spherical | Asahi Glass | SUNSPHERE H-51 | 1.45 | 3.0 |
| | silica: | Co., Ltd. | | | |
| | particle size | | | | |
| | 5.0 μm | | | | |
| | photoinitiator | Ciba | Irgacure-907 | | 4.5 |
| | | Specialty | | | |
| | | Chemicals | | | |
| | | Inc. | | | |
| | leveling agent | BYK Japan KK | BYK-323 | | 0.5 |
| | CAP | Eastman | CAP482-20 | | 5.5 |
| | | Chemical | | | |
| | | Japan Ltd. | | | |
| | solvent | | MEK | | 90.0 |
| | solvent | | xylene | | 10.0 |
| Com. | polyfunctional | Nippon Kayaku | KAYARAD DPHA | 1.50 | 79.5 |
| Ex. 1 | acrylate | Co., Ltd. | | | |
| | crosslinked | Soken | SX-350 | 1.59 | 10.0 |
| | polystyrene: | Chemical & | | | |
| | particle size | Engineering | | | |
| | 3.0 μm | Co., Ltd. | | | |
| | photoinitiator | Ciba | Irgacure-907 | | 4.5 |
| | | Specialty | | | |
| | | Chemicals | | | |
| | | Inc. | | | |
| | leveling agent | BYK Japan KK | BYK-323 | | 0.5 |
| | CAP | Eastman | CAP 482-20 | | 5.5 |
| | | Chemical | | | |
| | | Japan Ltd. | | | |
| | solvent | | MEK | | 100.0 |
| Com. | polyfunctional | DIC | 17-806 | 1.50 | 89.5 |
| Ex. 2 | acrylate | | | | |
| | porous silica: | Fuji Silycia | Sylosphere | 1.45 | 6.0 |
| | average | Chemical Ltd. | C-1504 | | |
| | particle size | | | | |
| | 4.5 μm | | | | |
| | photoinitiator | Ciba | Irgacure-907 | | 4.0 |
| | | Specialty | | | |
| | | Chemicals | | | |
| | | Inc. | | | |
| | leveling agent | BYK Japan KK | BYK-323 | | 0.5 |
| | solvent | | MEK | | 100.0 |
| Com. | polyfunctional | DIC | 17-806 | 1.50 | 87.5 |
| Ex. 3 | acrylate | | | | |
| | crosslinked | Soken | SX-350 | 1.59 | 8.0 |
| | polystyrene: | Chemical & | | | |
| | particle size | Engineering | | | |
| | 3.0 μm | Co., Ltd. | | | |
| | photoinitiator | Ciba | Irgacure-907 | | 4.0 |
| | | Specialty | | | |
| | | Chemicals | | | |
| | | Inc. | | | |
| | leveling agent | BYK Japan KK | BYK-323 | | 0.5 |
| | solvent | | MEK | | 100.0 |

RIS: refractive indexes
pbw: parts by weight

Distributions of slope angles of the anti-glare materials obtained in Examples 1 to 3 and Comparative Examples 1 to 3 were calculated and the results are shown in Table 2.

TABLE 2

| | distribution | distribution |
|---|---|---|
| | of slope | of slope |
| | angles A | angles B |
| Ex. 1 | 0.10 | 1.00 |
| Ex. 2 | 0.03 | 0.97 |
| Ex. 3 | 0.12 | 1.45 |
| Com. Ex. 1 | 0.29 | 2.26 |
| Com. Ex. 2 | 0.54 | 2.74 |
| Com. Ex. 3 | 0.00 | 0.39 |

The distributions in Table 2 above were calculated according to the procedure described below.

First, irregularity shape formed on the resin layers (on the surfaces not having translucent substrates) were measured, according to ASME/1995, using a surface roughness measuring instrument (trade name: Surfcorder SE 1700α, Kosaka Laboratory Ltd.). Conditions for measurement were as follows:

| Measuring length: | 4.0 mm |
|---|---|
| Filters: | GAUSS |
| λc(cutoff wavelength): | 0.8 |
| λf(waviness): | 10 λc |
| Vertical magnification: | 20,000 |
| Horizontal magnification: | 500 |

Next, for the whole length along which the irregularity shape were measured, heights (Y) of the irregularity shape for every 0.5 μm of the measured length (X) were calculated to calculate local slope of the profiles (ΔZᵢ) according to the equation below:

ΔZᵢ=(dYᵢ₊₃−9×dYᵢ₊₂+45×dYᵢ₊₁−45×dYᵢ₋₁+9×dYᵢ₋₂−dYᵢ₋₃)/(60×dXᵢ)

wherein ΔZᵢ refers to a local slope of the profile at a measurement location dXᵢ.

Then, slope angles (θ) were calculated according to the equation below:

θ=tan⁻¹|ΔZᵢ|

After obtaining the slope angles (θ) for the whole length of measurement according to the above equation, frequency distributions were created in increments of 0.1° of slope angles (θ) to give the proportion of those slope angles having the predetermined values defined according to the present invention.

Using the anti-glare materials obtained in Examples 1 to 3 and Comparative Examples 1 to 3, total haze values, internal haze values, total transmittance, definition of transmitted image, centerline average surface rougheness (Ra), mean spacings of irregularities (Sm), anti-glare properties, contrast and scintillation were measured and evaluated according to the procedure described below.

Haze values were measured according to JIS K7105, using a hazemeter (trade name: NDH 2000, Nippon Denshoku Industries Co., Ltd.).

Transparent sheets with pressure-sensitive adhesive used for measuring internal haze values were as follows.

### Transparent Sheet

Component: polyethylene terephthalate (PET)

Thickness: 38 μm

### Pressure-Sensitive Adhesive Layer

Component: acrylic pressure-sensitive adhesive

Thickness: 10 μm

Haze of the Transparent Sheet with Pressure-Sensitive Adhesive 3.42

Total transmittance was measured according to JIS K7105, using the hazemeter described above.

Definition of transmitted image was measured according to JIS K7105, using an image clarity meter (trade name: ICM-LDP, Suga Test Instruments Co., Ltd.) set to the transmission mode with an optical comb width of 0.5 mm.

Ra and Sm were measured according to JIS B0601-1994, using the surface roughness measuring instrument described above.

Anti-glare properties were rated as , ∘ and x when the values of definition of transmitted image were from 0 to 30, from 31 to 70 and from 71 to 100, respectively.

Contrast was measured as follows. A liquid crystal display (trade name: LC-37GX1W, Sharp Corporation) was laminated at the surface of the screen via a crystal-clear, pressure-sensitive adhesive layer on that side of the anti-glare material of each of Examples and Comparative Examples opposite to the side where the resin layer was formed and the liquid crystal display was irradiated with a fluorescent lamp (trade name: HH4125GL, Matsushita Electric Industrial Co., Ltd.) from 60° upward to the front of the liquid crystal display screen so that the illuminance at the liquid crystal display surface could be 200 lux. Thereafter, brightness were measured when the liquid crystal display was rendered white in color and black in color with a photometer/colorimeter (trade name: BM-5A, Topcon Corporation). Contrasts were then calculated by using the brightness (cd/m²) obtained when the display was rendered black in color and white in color according to the equation below and were rated as x, ∘ and when the values were from 600 to 800, from 801 to 1,000 and from 1,001 to 1,200, respectively.

Contrast=brightness of display in white/brightness of display in black

Scintillation was measured as follows. A liquid crystal display with a resolution of 50 ppi (trade name: LC-32GD4, Sharp Corporation), a liquid crystal display with a resolution of 100 ppi (trade name: LL-T1620-B, Sharp Corporation), a liquid crystal display with a resolution of 120 ppi (trade name: LC-37GX1W, Sharp Corporation), a liquid crystal display with a resolution of 140 ppi (trade name: VGN-TX72B, Sony Corporation), a liquid crystal display with a resolution of 150 ppi (trade name: nw8240-PM780, Hewlett-Packard Japan, Ltd.) and a liquid crystal display with a resolution of 200 ppi (trade name: PC-CV50FW, Sharp Corporation) were laminated at the surface of the screen via a crystal-clear, pressure-sensitive adhesive layer on that side of the anti-glare material of each of Examples and Comparative Examples opposite to the side where the resin layer was formed. The liquid crystal displays were rendered green in color in a dark room and then images were photographed by a CCD camera with a resolution of 200 ppi (CV-200C, Keyence Corporation) from a normal direction to each liquid crystal TV. Resolutions were measured when no dispersion in brightness was observed and rated as x, ∘ and when the values of resolution were from 0 to 50 ppi, from 51 to 140 ppi and from 141 to 200 ppi, respectively.

The results of evaluations according to the procedures described above are shown in Table 3.

TABLE 3

| | resin | | | | | | | | | |
|---|---|---|---|---|---|---|---|---|---|---|
| | layer | tot. | int. | Tot. | image | Ra | Sm | anti- | | |
| | (μm) | haze | haze | trans. | def. | (μm) | (μm) | glare | cont. | sci. |
| Ex. 1 | 8.0 | 12.0 | 4.9 | 92.1 | 54.0 | 0.11 | 177.0 | ◯ | | ◯ |
| Ex. 2 | 7.5 | 24.6 | 20.4 | 93.5 | 64.4 | 0.10 | 172.0 | ◯ | | |
| Ex. 3 | 8.0 | 29.6 | 25.4 | 93.9 | 59.4 | 0.12 | 140.0 | ◯ | | |
| Com. | 5.0 | 43.0 | 31.8 | 93.7 | 23.4 | 0.20 | 132.0 | | X | ◯ |
| Ex. 1 | | | | | | | | | | |
| Com. | 5.0 | 31.0 | 2.9 | 91.8 | 3.3 | 0.31 | 74.0 | | X | X |
| Ex. 2 | | | | | | | | | | |
| Com. | 12.9 | 31.0 | 30.8 | 94.0 | 59.5 | 0.09 | 219.1 | X | ◯ | ◯ |
| Ex. 3 | | | | | | | | | | |

tot. haze: total haze
int. haze: internal haze
tot. trans.: total transmittance
image def.: definition of transmitted image
cont.: contrast
sci.: scintillation

As apparent from the result in Table 3, the anti-glare materials of Examples 1 to 3 satisfied anti-glare properties, contrast and scintillation in a balanced manner, while the anti-glare materials of Comparative Examples 1 and 2 where the distribution of slope angle A exceeded 0.2 failed to satisfy contrast and scintillation and the anti-glare material of Comparative Example 3 where the distribution of slope angle B was smaller than 0.8 failed to satisfy anti-glare properties.

### INDUSTRIAL APPLICABILITY

As described above, anti-glare materials which satisfy anti-glare properties, contrast and scintillation in a balanced manner may be provided by providing microirregularity shape over the outermost surface of a translucent substrate and by controlling slope angles of the irregularity shape within appropriate ranges.

Examples and comparative examples for the present invention (2) will be illustrated below.

### Example 4

To 500 parts of NanoTech® alumina in alcohol dispersion by C. I. Kasei Co., Ltd. (particle size 31 nm, total solid content 15%) as a dispersion liquid of metal oxide fine particles, five parts of KBE-903 (γ-aminopropyltriethoxysilane) by Shin-Etsu Chemical Co., Ltd. was added as a surface modifier and agitated and mixed using a homogenizer at room temperature for ten minutes. Thereafter, continuing agitation, 0.2 part of triethylamine was diluted by ten-fold with methanol and added dropwise and agitation was continued at 60° C. for 12 hours to fully react the surface modifier. Next, the dispersion liquid was transferred to an ultrafiltration device (MQLSEP FSIO-FUS 1582 by Daicen Membrane Systems Ltd., membrane area 5 m², made of polyether sulfone, molecular cutoff 150,000, length 1129 mm×diameter 89 mm) to filter off unreacted surface modifier. The liquid was pumped so that the filtration pressure was 1.6 kg/m² and pure isopropanol was fed to the outside of the membrane. Filtration was continued, returning sol which passed through without being filtrated, until the sol was reduced to 60-70 percent of the original amount, after which pure isopropanol was added to maintain the concentration. Next, 200 parts of the dispersion liquid (15%) prepared above and 70 parts of TPGDA (tripropylene glycol diacrylate) were agitated with agitating blades and a Three-one motor (Heidon BL 300 R) to distill off alcohol content to obtain a sol of metal oxide fine particles according to the present invention (Liquid A). 30% by weight of the solid content of Liquid A were the metal oxide fine particles.

Next, a coating material for optically functional layers obtained by agitating a mixture noted in Table 4 containing Liquid A above with a disper for 30 minutes was applied by roll coating method on one side of a transparent substrate of TAC (FUJIFILM Corporation, TD80UL) 80 μm in thickness and 92% in total transmittance (line speed 20 m/min) and predried at 30 to 50° C. with an air flowrate of 0.5 m/sec for 20 seconds. Thereafter, drying was carried out at 100° C. for one minute, and then ultraviolet irradiation was carried out in a nitrogen atmosphere (nitrogen gas replacement) using four 120 W/m, beam-condensing, high-pressure mercury vapor lamps (irradiation distance 20 cm) to cure the coated film. In this manner, the optical layered product having an optically functional layer 6.0 μm in thickness of Example 4 was obtained.

### Example 5

In a similar manner to Example 4 except that the coating material for optically functional layers was replaced with the liquid mixture noted in Table 4 and the thickness of the optically functional layer was 9.0 μm, the optical layered product of Example 5 was obtained.

### Example 6

In a similar manner to Example 4, but using NANO BYK 3841, zinc oxide fine particles, of BYK Japan KK (particle size 40 nm, 40% dispersion, diluted with methoxypropylacetate) as a dispersion liquid of metal oxide fine particles, a sol of metal oxide fine particles (Liquid B) was obtained. 40% by weight of the solid content of Liquid B were the metal oxide fine particles. Next, a coating material for optically functional layers obtained by agitating the mixture noted in Table 4 containing Liquid B above with a disper for 30 minutes was applied by microgravure coating method on one side of a transparent substrate of TAC (Konica Minolta Opto, Inc., KC4UYW) 40 μm in thickness and 92% in total transmittance (line speed 20 m/min) and predried at 30 to 50° C. with an air flowrate of 0.5 m/sec for 20 seconds. Thereafter, drying was carried out at 80° C. for one minute, and then ultraviolet irradiation was carried out in a nitrogen atmosphere (nitrogen gas replacement) using four 100 W/cm, beam-condensing, high-pressure mercury vapor lamps (irradiation distance 20 cm) to cure the coated film. In this manner, the optical layered product having an optically functional layer 8.0 μm in thickness of Example 6 was obtained.

### Comparative Example 4

In a similar manner to Example 4 except that the coating material for optically functional layers was replaced with the liquid mixture noted in Table 4 and the thickness of the optically functional layer was 5.0 μm, the optical layered product of Comparative Example 4 was obtained.

### Comparative Example 5

In a similar manner to Example 4 except that the coating material for optically functional layers was replaced with the liquid mixture noted in Table 4 and the thickness of the optically functional layer was 7.0 μm, the optical layered product of Comparative Example 5 was obtained.

### Comparative Example 6

In a similar manner to Example 4 except that the coating material for optically functional layers was replaced with the liquid mixture noted in Table 4 and the thickness of the optically functional layer was 4.0 μm, the optical layered product of Comparative Example 6 was obtained.

### Comparative Example 7

In a similar manner to Example 4 except that the metal oxide fine particles were a sol of alumina 120 nm in particle size (Liquid C), the optical layered product of Comparative Example 7 was obtained. 30% by weight of the solid content of Liquid C were the metal oxide fine particles.

TABLE 4

| No. | components | manufacturers | trade names | pbw |
|---|---|---|---|---|
| Ex. 4 | polyfunctional | Toagosei Co., | M-305 | 63.5 |
| | acrylate | Ltd. | | |
| | polyfunctional | Shin-Nakamura | U-4HA | 21.5 |
| | urethane | Chemical Co., | | |
| | acrylate | Ltd. | | |
| | translucent | Sekisui Plastics | XX-27CR | 5.5 |
| | organic filler | Co., Ltd. | | |
| | (acrylic filler, | | | |
| | particle size | | | |
| | 3.5 μm | | | |
| | metal oxide fine | — | Liguid A | 1.0 |
| | particles | | | |
| | (alumina sol, | | | |
| | particle size 31 nm) | | | |
| | photoinitiator | Ciba Japan K.K. | Irgacure 907 | 4.5 |
| | leveling agent | BYK Japan KK | BYK-323 | 0.5 |
| | viscous agent | Eastman Chemical | CAB 381-20 | 3.5 |
| | | Japan Ltd. | | |
| | solvent | — | MIBK | 50.0 |
| | solvent | — | toluene | 50.0 |
| Ex. 5 | polyfunctional | Kyoeisha | PE-3A | 41.5 |
| | acrylate | Chemical Co., | | |
| | | Ltd. | | |
| | polyfunctional | Kyoeisha | UA-306I | 41.5 |
| | urethane | Chemical Co., | | |
| | acrylate | Ltd. | | |
| | translucent | Sekisui Plastics | XX-18 CR | 4.0 |
| | organic filler | Co., Ltd. | | |
| | (acrylic filler, | | | |
| | particle size | | | |
| | 3.5 μm) | | | |
| | translucent | Soken Chemical & | MX-500 | 3.0 |
| | organic filler | Engineering Co., | | |
| | (acrylic filler, | Ltd. | | |
| | particle size | | | |
| | 5.0 μm) | | | |
| | metal oxide fine | — | Liquid A | 1.5 |
| | particles | | | |
| | (alumina sol, | | | |
| | particle size 31 nm) | | | |
| | photoinitiator | Ciba Japan K.K. | Irgacure 184 | 4.5 |
| | leveling agent | BYK Japan KK | BYK-323 | 0.5 |
| | viscous agent | Eastman Chemical | CAB 381-20 | 3.5 |
| | | Japan Ltd. | | |
| | solvent | — | MIBK | 60.0 |
| | solvent | — | Toluene | 40.0 |
| Ex. 6 | polyfunctional | Kyoeisha | PE-3A | 57.0 |
| | acrylate | Chemical Co., | | |
| | | Ltd. | | |
| | polyfunctional | Kyoeisha | UA-306I | 24.0 |
| | urethane | Chemical Co., | | |
| | acrylate | Ltd. | | |
| | translucent | Sekisui Plastics | XX-27 CR | 4.0 |
| | organic filler | Co., Ltd. | | |
| | (acrylic filler, | | | |
| | particle size | | | |
| | 3.5 μm) | | | |
| | translucent | Sekisui Plastics | XX-21 CR | 3.0 |
| | organic filler | Co., Ltd. | | |
| | (acrylic filler, | | | |
| | particle size | | | |
| | 5.0 μm) | | | |
| | metal oxide fine | — | Liquid B | 7.5 |
| | particles (zinc | | | |
| | oxide sol, | | | |
| | particle size 40 nm) | | | |
| | photoinitiator | Ciba Japan K.K. | Irgacure 184 | 4.0 |
| | leveling agent | BYK Japan KK | BYK-323 | 0.5 |
| | solvent | — | MIBK | 50.0 |
| | solvent | — | toluene | 30.0 |
| Com. | polyfunctional | Kyoeisha | PE-3A | 83.5 |
| Ex. 4 | acrylate | Chemical Co., | | |
| | | Ltd. | | |
| | translucent | Soken Chemical & | SX 350 H | 9.0 |
| | organic filler | Engineering Co., | | |
| | (styrene-acrylic | Ltd. | | |
| | filler, particle | | | |
| | size 3.5 μm) | | | |
| | photoinitiator | Ciba Japan KK | Irgacure 184 | 5.0 |
| | leveling agent | BYK Japan KK | BYK-323 | 0.5 |
| | viscous agent | Eastman Chemical | CAB 381-20 | 2.0 |
| | | Japan Ltd. | | |
| | solvent | — | MIBK | 45.0 |
| | solvent | — | toluene | 35.0 |
| Com. | polyfunctional | Kyoeisha | PE-3A | 36.0 |
| Ex. 5 | acrylate | Chemical Co., | | |
| | | Ltd. | | |
| | polyfunctional | Kyoeisha | UA-306H | 15.0 |
| | urethane | Chemical Co., | | |
| | acrylate | Ltd. | | |
| | translucent | Sekisui Plastics | XX-27 CR | 2.5 |
| | organic filler | Co., Ltd. | | |
| | (acrylic filler, | | | |
| | particle size | | | |
| | 3.5 μm) | | | |
| | metal oxide fine | — | Liquid A | 40.0 |
| | particles | | | |
| | (alumina sol, | | | |
| | particle size | | | |
| | 31 nm) | | | |
| | photoinitiator | Ciba Japan KK | Irgacure 907 | 4.0 |
| | leveling agent | BYK Japan KK | BYK-323 | 0.5 |
| | viscous agent | Eastman Chemical | CAB 381-20 | 2.0 |
| | | Japan Ltd. | | |
| | solvent | — | MIBK | 50.0 |
| | solvent | — | Toluene | 50.0 |
| Com. | polyfunctional | Arakawa Chemical | 575 | 84.5 |
| Ex. 6 | acrylate | Industries, Ltd. | | |
| | inorganic filler | Fuji Silycia | Sylophobic | 9.0 |
| | (silica, average | Chemical Ltd. | 702 | |
| | particle size | | | |
| | 4.1 μm) | | | |
| | photoinitiator | Ciba Japan KK | Irgacure 907 | 4.0 |
| | leveling agent | BYK Japan KK | BYK-323 | 0.5 |
| | viscous agent | Eastman Chemical | CAB 381-20 | 2.0 |
| | | Japan Ltd. | | |
| | solvent | — | MEK | 30.0 |
| | solvent | — | MIBK | 30.0 |
| | solvent | — | toluene | 40.0 |
| Com. | polyfunctional | Toagosei Co., | M-305 | 73.0 |
| Ex. 7 | acrylate | Ltd. | | |
| | translucent | Sekisui Plastics | XX-27 CR | 5.5 |
| | organic filler | Co., Ltd. | | |
| | (acrylic filler, | | | |
| | particle size | | | |
| | 3.5 μm) | | | |
| | metal oxide fine | — | Liquid C | 15.0 |
| | particles | | | |
| | (alumina sol, | | | |
| | particle size | | | |
| | 120 nm) | | | |
| | photoinitiator | Ciba Japan KK | Irgacure 907 | 4.0 |
| | leveling agent | BYK Japan KK | BYK-323 | 0.5 |
| | viscous agent | Eastman Chemical | CAB 381-20 | 2.0 |
| | | Japan Ltd. | | |
| | solvent | — | MIBK | 50.0 |
| | solvent | — | toluene | 50.0 |

Coating Adhesion

Measured according to the crosscutting of JIS K5600. Eleven cuts were made at an interval of 1 mm. Evaluations were made as the percentage of the number of crosscut grids which were not delaminated. For example, when five grids were delaminated, it was designated as 95/100.

Total Transmittance

Measured according to JIS K7105, using a hazemeter (trade name: NDH 2000, Nippon Denshoku Industries Co., Ltd.).

Haze Values

Measured according to JIS K7105, using a hazemeter (trade name: NDH 2000, Nippon Denshoku Industries Co., Ltd.).

An “internal haze value” refers to a value obtained by subtracting a haze value of a transparent sheet with pressure-sensitive adhesive from a haze value of an optical layered film having laminated the transparent sheet over the microirregularity shape surface of the optical layered film.

Transparent sheets with pressure-sensitive adhesive used for measuring internal haze values were as follows:

### Transparent Sheet

Component: polyethylene terephthalate (PET), 38 μm in thickness

### Pressure-Sensitive Adhesive Layer

Component: acrylic pressure-sensitive adhesive, 10 μm in thickness

Haze of Transparent Sheet with Pressure-Sensitive Adhesive 3.42

External haze values were calculated using the haze values and the internal haze values according to the equation below:

External haze value=haze value−internal haze value

Definition of Transmitted Image

Measured according to JIS K7105, using an image clarity meter (trade name: ICM-IDP, Suga Test Instruments Co., Ltd.) set to the transmission mode with an optical comb width of 0.5 mm.

Scratch Resistance

Steel wool #0000 of NihonSteelWool Co., Ltd. was attached to an abrasion resistance tester (Abrasion Tester, Model 339, Fu Chien) and the optically functional layer was shuttled ten times with a load of 250 g/cm². Thereafter, scratches on the abraded portion were observed under fluorescent lighting. Rating was made as , ∘, Δ or x when the number of scratches was 0, from 1 to less than 10, from 10 to less than 30 or 30 or more, respectively.

Surface Hardness (Pencil Hardness)

Measured according to JIS 5400, using a pencil hardness tester (Yoshimitsu Seiki). Five measurements were made and the number of unscratched runs was counted. For example, using 3H pencils, absence of three scratches was designated as 3/5(3H). Pencil hardnesses at 4/5(3H) or higher were considered good.

Anti-Glare Properties

Anti-glare properties were rated as , ∘ and x when the values of definition of transmitted image were from 0 to 30, from 31 to 70 and from 71 to 100, respectively.

Contrast (C/R)

Contrast was measured as follows. A liquid crystal display (trade name: LC-37GX1W, Sharp Corporation) was laminated at the surface of the screen via a crystal-clear, pressure-sensitive adhesive layer on that side of the optical layered product of each of Examples and Comparative Examples opposite to the side where the optical layered product was formed and the liquid crystal display was irradiated with a fluorescent lamp (trade name: HH4125GL, Matsushita Electric Industrial Co., Ltd.) from 60° upward to the front of the liquid crystal display screen so that the illuminance at the liquid crystal display surface could be 200 lux. Thereafter, brightness were measured when the liquid crystal display was rendered white in color and black in color with a photometer/colorimeter (trade name: BM-5A, Topcon Corporation). Contrasts were then calculated by using the brightness (cd/m²) obtained when the display was rendered black in color and white in color according to the equation below and were rated as x, ∘ and when the values were from 600 to 800, from 801 to 1,000 and from 1,001 to 1,200, respectively.

Contrast=brightness of display in white/brightness of display in black

Scintillation

A liquid crystal display with a resolution of 50 ppi (trade name: LC-32GD4, Sharp Corporation), a liquid crystal display with a resolution of 100 ppi (trade name: LL-T1620-B, Sharp Corporation), a liquid crystal display with a resolution of 120 ppi (trade name: LC-37GX1W, Sharp Corporation), a liquid crystal display with a resolution of 140 ppi (trade name: VGN-TX72B, Sony Corporation), a liquid crystal display with a resolution of 150 ppi (trade name: nw8240-PM780, Hewlett-Packard Japan, Ltd.) and a liquid crystal display with a resolution of 200 ppi (trade name: PC-CV50FW, Sharp Corporation) were laminated at the surface at the screen via a crystal-clear, pressure-sensitive adhesive layer on the side opposite the side where the optical layered product of each of Examples and Comparative Examples was formed. The liquid crystal displays were rendered green in color in a dark room and then images were photographed by a CCD camera with a resolution of 200 ppi (CV-200C, Keyence Corporation) from a normal direction to each liquid crystal TV. Scintillation was rated as x, ∘ and when the values of resolution were from 0 to 50 ppi, from 51 to 140 ppi and from 141 to 200 ppi, respectively when no dispersion in brightness was observed.

Uneven Distribution

Sections of an optically functional layer composing a optical layered product were prepared and their cross sections were observed through transmission electron microscopy (TEM). The number of metal oxide fine particles per μm of the peripheral length of the cross section of the translucent organic filler of the metal oxide fine particles observed around the cross section of the translucent organic filler ([the number of metal oxide fine particles observed around the cross section (on the surface) of the translucent filler]/[peripheral length of the cross section of translucent organic filler]) was calculated. A TEM photograph of a cross section of the optically functional layer of Example 4 is shown in FIG. 1. A TEM photograph of Comparative Example 4 is shown in FIG. 2.

Table 5 summarized the results of evaluations.

TABLE 5

| | | | Haze | | | ima. | scr. | | anti | | | |
|---|---|---|---|---|---|---|---|---|---|---|---|---|
| | adh. | tr. | tot. | int. | ex. | def. | res. | P.H. | glare | C/R | sci. | ud. |
| E4 | 100/100 | 92.3 | 10.8 | 5.4 | 5.4 | 55 | ◯ | 4/5 (3H) | ◯ | ◯ | ◯ | 7 |
| E5 | 100/100 | 92.6 | 8.0 | 6.0 | 2.0 | 68 | | 4/5 (4H) | ◯ | | ◯ | 15 |
| E6 | 100/100 | 92.0 | 12.0 | 7.0 | 5.0 | 49 | ◯ | 4/5 (3H) | ◯ | ◯ | ◯ | 35 |
| CE4 | 100/100 | 93.1 | 38.0 | 26.0 | 12.0 | 28 | X | 4/5 (3H) | | X | | 0 |
| CE5 | 100/100 | 92.5 | 4.3 | 2.3 | 2.0 | 83 | | 2/5 (4H) | X | X | ◯ | 70 |
| CE6 | 100/100 | 91.2 | 28.0 | 2.0 | 26.0 | 2 | | 3/5 (3H) | | X | X | 0 |
| CE7 | 100/100 | 91.5 | 32.0 | 25.0 | 7.0 | 27 | ◯ | 3/5 (3H) | | X | ◯ | 6 |

adh: adhesion
tr: total transmittance
ima. def.: definition of transmitted image
scr. res.: scratch resistance
P.H.: pencil hardness
sci.: scintillation
ud.: uneven distribution

### BRIEF DESCRIPTION OF THE DRAWINGS

FIG. 1 is a TEM photograph of a cross section of the optically functional layer of Example 4; and

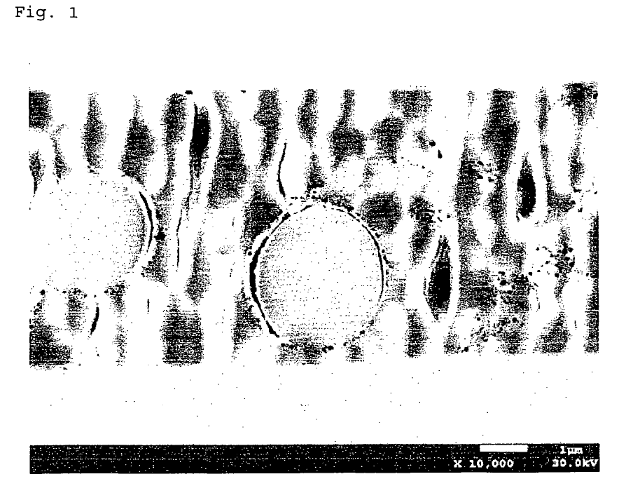

FIG. 2 is a TEM photograph of a cross section of the optically functional layer of Comparative Example 4.

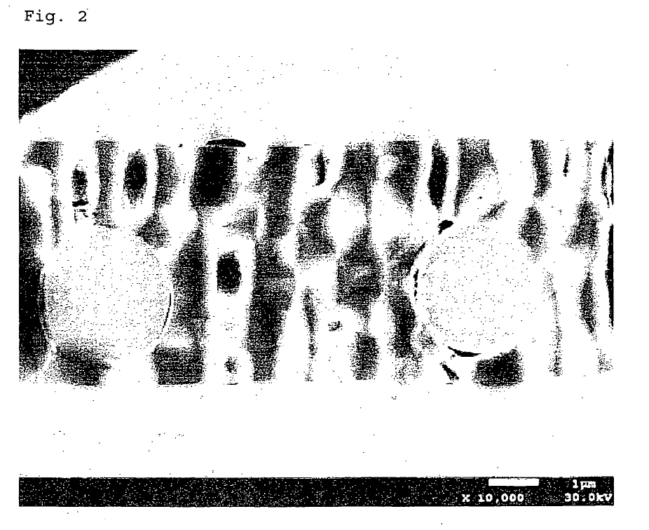

The entire disclosures of Japanese Patent Application No. 2007-299882 and Japanese Patent Application No. 2008-249341, including claims, specification, drawings and summaries, are incorporated herein by reference.

What is claimed is:

1. An anti-glare material comprising irregularity shape formed over at least one side, wherein the side comprising the irregularity shape has slope angles satisfying the distribution conditions according to the formulae (1) and (2):
A≦0.2 (1) and
0.8≦B≦2.5 (2)
wherein
A: proportion of slope angles at or greater than 1.6° in relation to the total, B: (proportion of slope angles at or greater than 0.4° and smaller than 1.6° in relation to the total)/(proportion of slope angles less than 0.4° in relation to the total).

2. The anti-glare material according to claim 1, which comprises a translucent substrate on which a resin layer is layered.

3. The anti-glare material according to claim 2, wherein the resin layer includes translucent resin fine particles and comprises the irregularity shape formed over the surface opposite to the surface on which the translucent substrate is layered.

4. The anti-glare material according to claim 1, wherein the irregularity shape have a mean spacing of profile irregularities (Sm) of 50 to 250 μm.

5. The anti-glare material according to claim 1, which has an internal haze of 5 to 40.

6. The anti-glare material according to claim 2, which comprises a low-reflection layer layered on the resin layer.

7. An optical layered product comprising at least an optically functional layer provided directly or via another layer on one or both sides of a translucent substrate, wherein the optically functional layer contains:
a translucent resin as a matrix;
a translucent organic filler dispersed through the translucent resin; and
metal oxide fine particles having a particle size of 1 to 100 nm, incorporated at a mix proportion of 0.1 to 10% by weight, the metal oxide fine particles being unevenly distributed toward the surface of the translucent organic filler.

8. The optical layered product according to claim 7, wherein the metal oxide fine particles are alumina fine particles.

9. A process for producing an optical layered product, comprising the steps of
applying a coating material made by mixing at least an energy-curable resin composition, a translucent organic filler and a metal oxide sol to one or both sides of a translucent substrate directly or via another layer; and
after the step of applying, applying an energy to cure the energy-curable resin composition to form an optically functional layer.

10. The process for producing the optical layered product according to claim 9, wherein the metal oxide sol is alumina sol.
